(19) United States
(12) Patent Application Publication
(10) Pub. No.: US 2020/0058201 A1
(43) Pub. Date: Feb. 20, 2020

(54) DISPLAY LIGHT-EQUIPPED TRANSMITTER

(71) Applicant: HOCHIKI Corporation, Tokyo (JP)

(72) Inventor: Kenji Mochida, Tokyo (JP)

(21) Appl. No.: 16/663,951

(22) Filed: Oct. 25, 2019

Related U.S. Application Data
(63) Continuation-in-part of application No. PCT/JP2018/012375, filed on Mar. 27, 2018.

(30) Foreign Application Priority Data
Apr. 26, 2017 (JP) 2017-087371
May 25, 2017 (JP) 2017-103751

(51) Int. Cl. G08B 5/36; F21V 15/01

(52) U.S. Cl. CPC G08B 5/36; F21V 15/01

(57) ABSTRACT

A display light-equipped transmitter 100 providing notification of an abnormality in a monitoring region includes a light emitting unit and a front cover 1 covering the light emitting unit from a front side of the display light-equipped transmitter 100 and provided with a transmitting region 13 transmitting light emitted by the light emitting unit to an outside of the display light-equipped transmitter 100 on a front side of the display light-equipped transmitter 100 and a non-transmitting region 14 not transmitting light emitted by the light emitting unit to an outside of the display light-equipped transmitter 100 on a front side of the display light-equipped transmitter 100.

### CROSS REFERENCE TO RELATED APPLICATIONS

### Related Application(s)

This application is a Continuation-In-Part of PCT Application No. PCT/JP2018/012375, filed Mar. 27, 2018, which claims priority to Japanese Application No. 2017-087371, filed Apr. 26, 2017 and Japanese Application No. 2017-103751, filed on May 25, 2017, the contents of which are all incorporated herein by reference.

### INCORPORATION BY REFERENCE

All publications and patent applications mentioned in this specification are herein incorporated by reference in their entirety to the same extent as if each individual publication or patent application was specifically and individually indicated to be incorporated by reference.

### TECHNICAL FIELD

The present invention relates to a display light-equipped transmitter.

This application claims the benefit of Japanese Patent Application No. 2017-087371 filed on Apr. 26, 2017 and Japanese Patent Application No. 2017-103751 filed on May 25, 2017, which are incorporated herein by reference in their entirety.

### BACKGROUND ART

According to the related art, a display light device emitting light in order to display the position of a fire notification transmitter is provided in a building or the like (Patent Document 1).

### CITATION LIST

### Patent Document

Patent Document 1: Laid-open Patent Application Publication in Japan No. H9-265594

### SUMMARY OF THE INVENTION

### Technical Problem

However, this display light device is configured to be separate from the transmitter and provided next to the transmitter so as to protrude to a relatively large extent from an installation surface so that the position of the transmitter is displayed in every direction. As a result, the display light device may act as, for example, a hindrance in the building.

Although a retrofit display light device that can be retrofitted into the transmitter according to the related art has been proposed, conceivable are the following first and second problems.

Proposed with regard to the first problem is the retrofit display light device according to the related art being configured to be flat as a whole, being configured to be retrofittable into the transmitter according to the related art by means of a screw or the like, and being configured such that a display light is provided along the periphery of the transmitter in the case of retrofitting into the transmitter.

However, this retrofit display light device may become dirty as a contaminant such as rain and dust enters the device from the gap between the transmitter (that is, a part emitting no light) and the retrofit display light device (light emitting part) in a case where, for example, the retrofit display light device is retrofitted into the transmitter. Besides, as for this retrofit display light device, the transmitter and the retrofit display light device as a whole may, for example, lack a sense of unity and give an impression of complexity as the retrofit display light device is retrofitted into the transmitter.

Accordingly, there is room for improvement in terms of contaminant infiltration prevention and overall design improvement.

Proposed with regard to the second problem is the retrofit display light device according to the related art being configured to be flat as a whole and being configured to be retrofittable into the transmitter according to the related art by means of a screw or the like. Specifically, according to the proposal, the retrofit display light device is configured to surround the periphery of the transmitter with the transmitter exposed toward a front surface side, a display light is provided at this surrounding part (hereinafter, referred to as the surrounding part), and the retrofit display light device is configured such that the display light is provided along the periphery of the transmitter in the case of retrofitting into the transmitter.

However, this retrofit display light device is configured such that, for example, the light of the display light is emitted only toward the front surface side with the display light embedded at the surrounding part so that the overall shape of the retrofit display light device is flat. As a result, it may be difficult to visually recognize the light of the display light from the side surface side of the transmitter in a case where the retrofit display light device is retrofitted into the transmitter.

Accordingly, there is room for improvement in terms of transmitter position recognition by a user.

It is an object of the present invention to solve the problems of the above mentioned prior arts.

### Solution to Problem

One aspect of the present invention provides a display light-equipped transmitter providing notification of an abnormality in a monitoring region, the display light-equipped transmitter comprises: a light emitting unit; and a front cover.

### BRIEF DESCRIPTION OF THE DRAWINGS

FIG. 1 is a perspective view of a display light-equipped transmitter according to Embodiment 1.

FIG. 2 is a front view of the display light-equipped transmitter.

FIG. 3 is a side view of the display light-equipped transmitter.

FIG. 4 is a cross-sectional view taken along the A-A arrow in FIG. 2.

FIG. 5 is an exploded perspective view of the display light-equipped transmitter as viewed from a front surface side.

FIG. 6 is an exploded perspective view of the display light-equipped transmitter as viewed from a back side.

FIG. 7 is a diagram in which FIG. 4 is enlarged in part.

FIG. 8 is a diagram in which FIG. 2 is enlarged in part and illustrates a state where a display plate is open.

FIG. 9 is a perspective view of a display light-equipped transmitter according to Embodiment 2.

FIG. 10 is a front view of the display light-equipped transmitter.

FIG. 11 is a side view of the display light-equipped transmitter.

FIG. 12 is a rear view of the display light-equipped transmitter.

FIG. 13 is a cross-sectional view taken along the A1-A1 arrow in FIG. 10.

FIG. 14 is an exploded perspective view of a part of the display light-equipped transmitter as viewed from the front surface side.

FIG. 15 is an exploded perspective view of a part of the display light-equipped transmitter as viewed from the back side.

FIG. 16 is a diagram in which FIG. 10 is enlarged in part and illustrates a state where a display plate is open.

FIG. 17 is a perspective view of a display light-equipped transmitter that is attached to a sheet metal according to Embodiment 3.

FIG. 18 is a perspective view of the display light-equipped transmitter that is removed from the sheet metal.

FIG. 19 is a front view of the display light-equipped transmitter.

FIG. 20 is a side view of the display light-equipped transmitter.

FIG. 21 is a rear view of the display light-equipped transmitter.

FIG. 22 is a cross-sectional view taken along the B1-B1 arrow in FIG. 19.

FIG. 23 is a diagram in which FIG. 22 is enlarged in part.

### MODE FOR CARRYING OUT THE INVENTION

Hereinafter, embodiments of a display light-equipped transmitter (a transmitter with indicator lamp) according to the invention will be described in detail based on accompanying drawings. The invention is not limited by the embodiments.

### Basic Concept of Embodiment 1

The basic concept of Embodiment 1 will be described first. Embodiment 1 relates generally to the display light-equipped transmitter. Here, “display light-equipped transmitter” is a notification unit that provides notification of an abnormality in a monitoring region. Specifically, “display light-equipped transmitter” is provided with at least a light emitting unit and is attached to, for example, an attachment target. “Display light-equipped transmitter” is, for example, a device providing the abnormality notification by being operated by a user in the monitoring region in a case where the abnormality in the monitoring region has occurred.

“Monitoring region” is a monitoring target region and is a concept including, for example, regions outside buildings and rooms, stairs, and corridors inside buildings. “Abnormality” means the monitoring region entering an unusual state and is a concept including, for example, the outbreak of a fire and toxic gas leakage in the monitoring region.

“Light emitting means” outputs light and is a concept including, for example, an organic EL, an inorganic EL, and a light emitting diode (LED) as electroluminescent light sources, a fluorescent light and a mercury lamp as discharge emission light sources, and an incandescent bulb and a halogen bulb emitting incandescent light.

“Attachment target” is an object to which the display light-equipped transmitter is attached and is a concept including, for example, a wall in the monitoring region and a sheet metal in the monitoring region. “Sheet metal in monitoring region” is a sheet metal of a disaster prevention facility provided in the monitoring region and is a concept including, for example, a sheet metal of a fire hydrant box accommodating at least a fire hydrant facility (such as a hose) and a sheet metal of an equipment storage box accommodating at least an electric bell or the like. A method for attaching the display light-equipped transmitter from the front surface side of the attachment target, a method for attaching the display light-equipped transmitter from the back side of the attachment target, or the like can be mentioned with regard to the attachment of the display light-equipped transmitter to the attachment target.

Described below in Embodiment 1 is a case where “abnormality” is “outbreak of fire in monitoring region”, a “light emitting unit” is a “light emitting diode”, an “attachment target” is a “sheet metal of fire hydrant box”, and the display light-equipped transmitter is attached from the front surface side of the attachment target.

### Basic Concepts of Embodiments 2 and 3

Next, the basic concepts of Embodiments 2 and 3 will be described. Embodiments 1 and 2 relate generally to the display light-equipped transmitter. Here, “display light-equipped transmitter” is a notification unit that provides notification of an abnormality in a monitoring region. Specifically, “display light-equipped transmitter” is provided with at least a light emitting unit, is attached to, for example, an attachment target, and is attached to the attachment target from the front surface side or the back side of the attachment target. “Display light-equipped transmitter” is, for example, a device providing the abnormality notification by being operated by a user in the monitoring region in a case where the abnormality in the monitoring region has occurred.

“Monitoring region” is a monitoring target region and is a concept including, for example, regions outside buildings and rooms, stairs, and corridors inside buildings. “Abnormality” means the monitoring region entering an unusual state and is a concept including, for example, the outbreak of a fire and toxic gas leakage in the monitoring region.

A “light emitting unit” outputs light and is a concept including, for example, an organic EL, an inorganic EL, and a light emitting diode (LED) as electroluminescent light sources, a fluorescent light and a mercury lamp as discharge emission light sources, and an incandescent bulb and a halogen bulb emitting incandescent light.

“Attachment target” is an object to which the display light-equipped transmitter is attached and is a concept including, for example, a wall in the monitoring region and a sheet metal in the monitoring region. “Sheet metal in monitoring region” is a sheet metal of a disaster prevention facility provided in the monitoring region and is a concept including, for example, a sheet metal of a fire hydrant box accommodating at least a fire hydrant facility (such as a hose) and a sheet metal of an equipment storage box accommodating at least an electric bell or the like. A method for attaching the display light-equipped transmitter from the front surface side of the attachment target, a method for attaching the display light-equipped transmitter from the back side of the attachment target, or the like can be mentioned with regard to the attachment of the display light-equipped transmitter to the attachment target.

Described below in Embodiments 2 and 3 is a case where “abnormality” is “outbreak of fire in monitoring region”, a “light emitting unit” is a “light emitting diode”, and an “attachment target” is a “sheet metal of fire hydrant box”. Described in Embodiment 2 in particular is a case where the display light-equipped transmitter is attached from the front surface side of the attachment target. Described in Embodiment 3 in particular is a case where the display light-equipped transmitter is attached from the back side of the attachment target.

### Embodiment 1

Embodiment 1 will be described first. Described in this embodiment is a case where the transmitting and non-transmitting regions of the front cover in the display light-equipped transmitter are configured integrally with each other.

(Configuration)

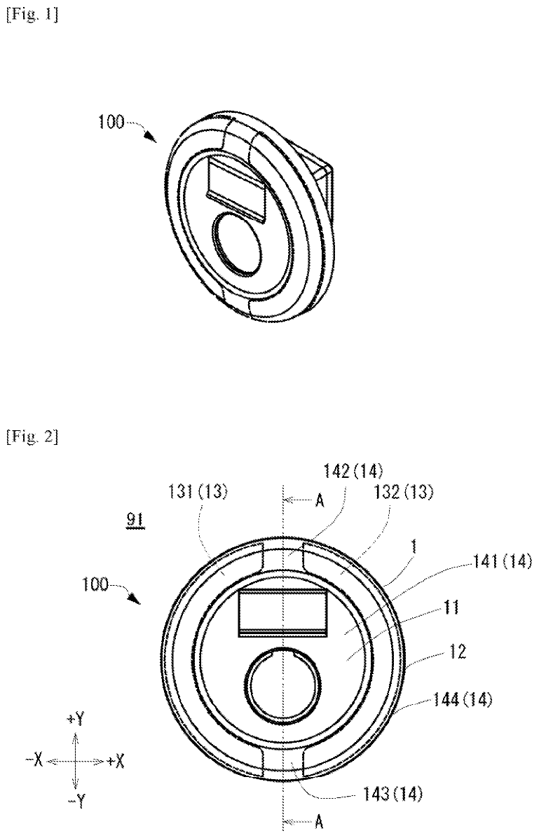

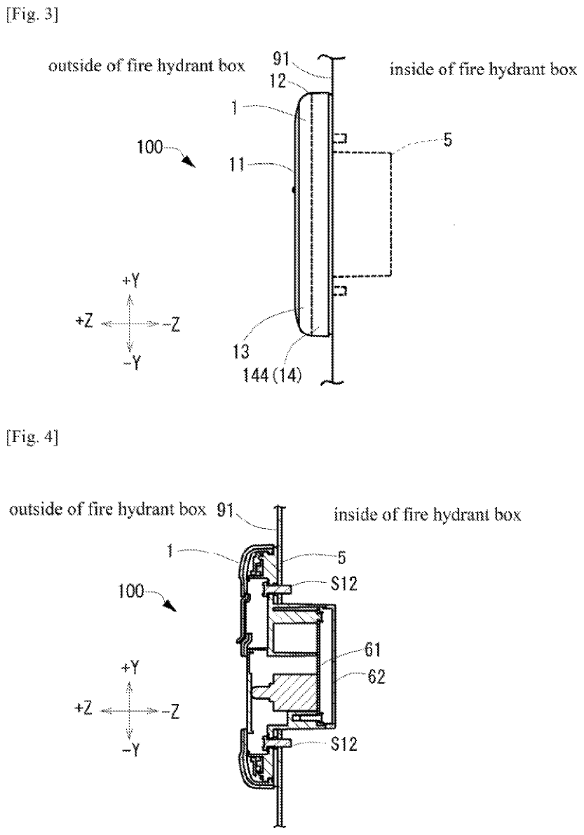

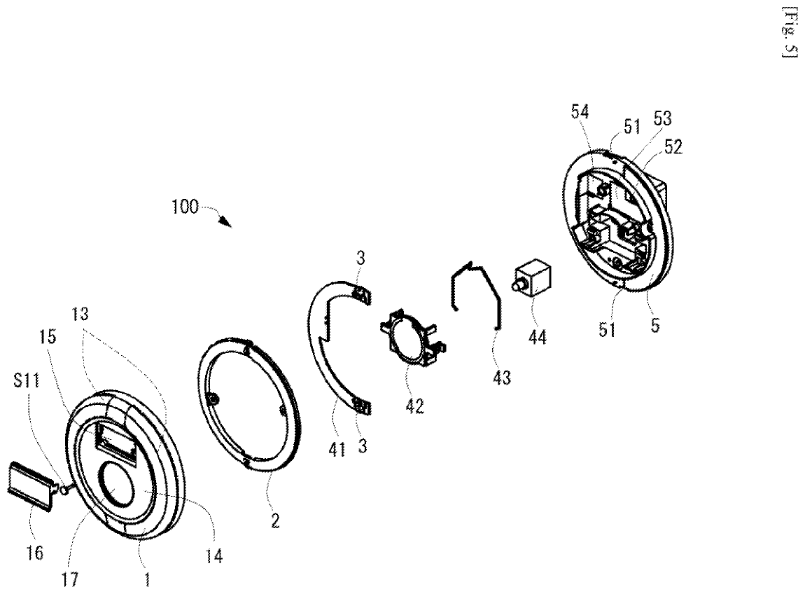

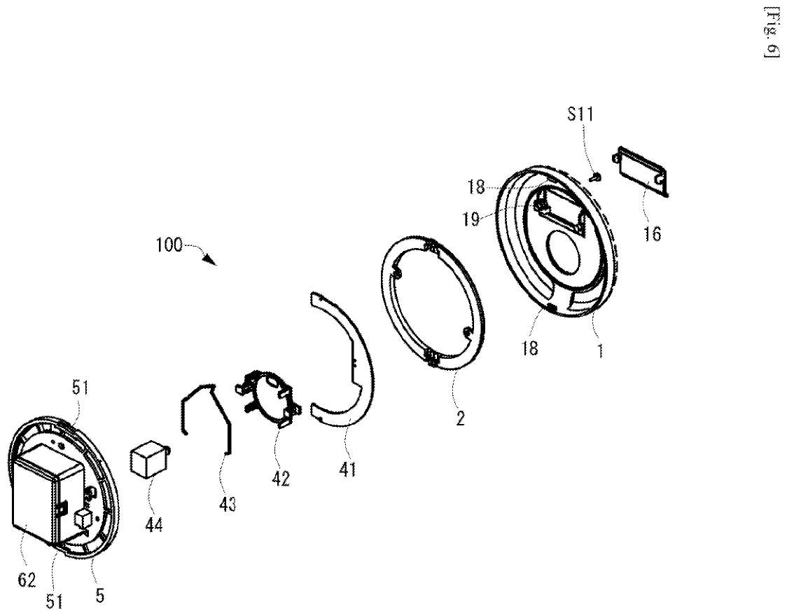

The configuration of the display light-equipped transmitter according to the present embodiment will be described first. FIG. 1 is a perspective view of the display light-equipped transmitter according to the present embodiment. FIG. 2 is a front view of the display light-equipped transmitter. FIG. 3 is a side view of the display light-equipped transmitter. FIG. 4 is a cross-sectional view taken along the A-A arrow in FIG. 2. FIG. 5 is an exploded perspective view of the display light-equipped transmitter as viewed from the front surface side. FIG. 6 is an exploded perspective view of the display light-equipped transmitter as viewed from the back side. A state of being attached to a sheet metal 91 is illustrated in FIGS. 2 to 4. In the following description, the X-Y-Z directions illustrated in FIGS. 2 to 4 are mutually orthogonal. Specifically, the Y direction is a vertical direction and the X direction and the Z direction are horizontal directions orthogonal to the vertical direction. For example, the Y direction will be referred to as up-down direction, the +Y direction will be referred to as upper side, the −Y direction will be referred to as lower side, the X direction will be referred to as left-right direction, the +X direction will be referred to as right side, the −X direction will be referred to as left side, the Z direction will be referred to as thickness direction, the +Z direction will be referred to as front surface side, and the −Z direction will be referred to as back side. In the following description, terms relating to “X-Y-Z directions” are convenient expressions for describing the relative positional relationships (or the directions) of components and the like in an illustrated display light-equipped transmitter 100 with the directions that are along the XY plane (that is, the directions including the +X, −X, +Y, and −Y directions) referred to as side surface side and the direction including the side surface side and the front surface side referred to as front side. Hereinafter, details of particularly characteristic configurations will be described after the configuration of the display light-equipped transmitter 100 as a whole is described.

The display light-equipped transmitter 100 illustrated in each of the drawings is a notification unit that provides notification of an abnormality in a monitoring region. Specifically, the display light-equipped transmitter 100 is a device providing notification of the outbreak of a fire in the monitoring region. The display light-equipped transmitter 100 is attached to the sheet metal 91 of a fire hydrant box as illustrated in FIG. 4. The display light-equipped transmitter 100 is provided with, for example, a front cover 1, a light guide 2, light emitting units 3, a display light board 41, a protective plate 42, a pressing spring 43, a switch 44, and a component plate 5 illustrated in FIG. 5 and a transmitter board 61 and a board cover 62 illustrated in FIG. 4.

(Configuration-Front Cover)

The front cover 1 is a cover unit that covers at least the light emitting unit 3 from the front side. For example, a transmitting region 13 and a non-transmitting region 14 in FIG. 5, which will be described later, are configured integrally with each other in the front cover 1. The front cover 1 has a disk-shaped outer shape as a whole. The front cover 1 will be described in detail later.

(Configuration-Light Guide)

The light guide 2 is a light guiding unit that guides the light that is emitted by the light emitting unit 3. Specifically, the light guide 2 is provided along the front cover 1 over the entire transmitting region 13. The light guide 2 can be of any specific type and configuration. For example, the light guide 2 is provided between the front cover 1 and the display light board 41 in the thickness direction (Z direction), is annularly formed so as to surround the switch 44, has an annular shape, and is formed of any light guiding material (such as a transparent resin material).

(Configuration-Light Emitting Unit)

The light emitting unit 3 is a light emitting unit that emits light. Specifically, the light emitting unit 3 emits light toward the light guide 2. The light emitting unit 3 can be of any specific type and configuration. For example, the light emitting units 3 are light emitting diodes mounted on the display light board 41 and provided at positions close to the upper side (+Y direction) and the lower side (−Y direction) in the display light-equipped transmitter 100.

(Configuration-Display Light Board)

The display light board 41 is a circuit board on which the light emitting unit 3 is mounted. Specifically, the display light board 41 is provided on the side that is opposite to the front cover 1 with respect to the light guide 2. The display light board 41 can be of any specific type and configuration. For example, the display light board 41 is configured to connect the positions of the light emitting units 3 while avoiding the switch 44 and is configured in a circular arc shape facing only a part of the left side (−X direction) of the light guide 2.

(Configuration-Protective Plate)

The protective plate 42 is an operation unit that operates the display light-equipped transmitter 100. Specifically, the protective plate 42 is for protecting the switch 44 and is pressed by a user in the event of an abnormality. The protective plate 42 can be of any specific type and configuration. For example, the protective plate 42 is provided so as to be partially exposed via an exposing opening portion 17 of the front cover 1.

(Configuration-Pressing Spring)

The pressing spring 43 is an operation unit that operates the display light-equipped transmitter 100. Specifically, the pressing spring 43 is operated by a user so that the protective plate 42 in a pressed state returns to the original position of the protective plate 42. The pressing spring 43 can be of any specific type and configuration. For example, the pressing spring 43 is bent so as to be provided around the switch 44.

(Configuration-Switch)

The switch 44 is an operation unit that operates the display light-equipped transmitter 100. Specifically, the switch 44 is provided on the center side of the display light-equipped transmitter 100 in the direction along a front surface portion 11 of the front cover 1 and is pressed via the protective plate 42 and by a user in the event of an abnormality. The switch 44 can be of any specific type and configuration. For example, the switch 44 can be configured as a push button switch.

(Configuration-Component Plate)

The component plate 5 is a cover unit that covers at least the light emitting unit 3 from the back side (−Z direction). For example, the component plate 5 is resinous and is a back cover that is circular as a whole. The component plate 5 will be described in detail later.

(Configuration-Transmitter Board)

The transmitter board 61 in FIG. 4 is a transmitter circuit board on which an electric circuit for operating the display light-equipped transmitter 100 is mounted. The transmitter board 61 can be of any specific type and configuration. For example, the transmitter board 61 has a rectangular shape as a whole and is fixed to the back side of the component plate 5 by any method (such as screwing with a screw).

(Configuration-Board Cover)

The board cover 62 is a cover unit that covers the transmitter board 61 from the back side (−Z direction). The board cover 62 can be of any specific configuration and type. For example, the board cover 62 has a rectangular shape as a whole and is engaged with and attached to the component plate 5.

(Configuration-Details)

Next, details of the front cover 1 and the component plate 5 will be described.

(Configuration-Details-Front Cover)

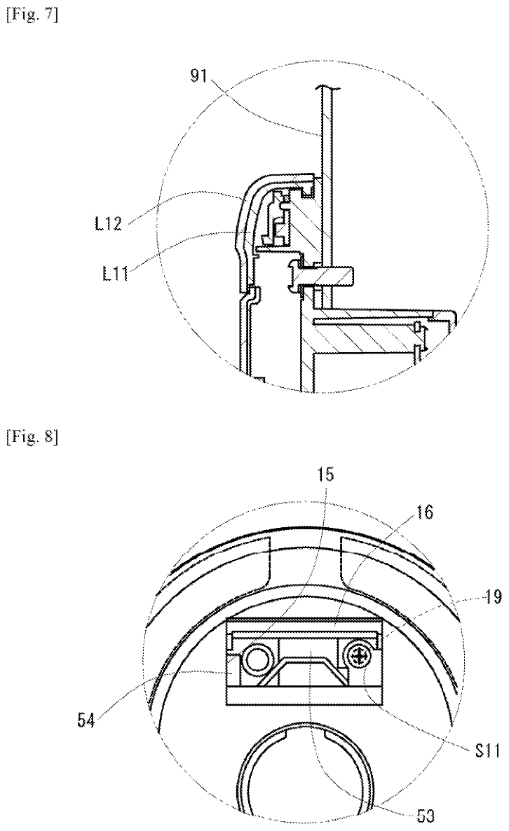

FIG. 7 is a diagram in which FIG. 4 is enlarged in part. FIG. 8 is a diagram in which FIG. 2 is enlarged in part and illustrates a state where a display plate is open. The front cover 1 illustrated in FIGS. 2 and 3 is provided with the front surface portion 11, a side surface portion 12, the transmitting region 13, the non-transmitting region 14, a non-transmitting layer L11 and a transmitting layer L12 in FIG. 7, an opening and closing opening portion 15, a display plate 16, and the exposing opening portion 17 in FIG. 5, and a front cover side engagement portion 18 and a front cover side fixing portion 19 in FIG. 6.

(Configuration-Front Cover-Front Surface Portion)

The front surface portion 11 in FIGS. 2 and 3 covers the light emitting unit 3 from the front surface side (+Z direction) of the display light-equipped transmitter 100 and constitutes a part of the outer shape of the front cover 1. For example, the front surface portion 11 is circular and along the XY plane, continues to the side surface portion 12 with the outside edge of the front surface portion 11 slightly curved, and is configured integrally with the side surface portion 12.

(Configuration-Details-Front Cover-Side Surface Portion)

The side surface portion 12 in FIGS. 2 and 3 covers the light emitting unit 3 from the side surface side of the display light-equipped transmitter 100 and constitutes another part of the outer shape of the front cover 1. For example, the side surface portion 12 is partially curved from the outside edge of the front surface portion 11, extends toward the back side (−Z direction), continues from the front surface portion 11, and is configured integrally with the front surface portion 11.

(Configuration-Details-Front Cover-Transmitting Region)

The transmitting region 13 in FIGS. 2 and 3 is a region through which the light that is emitted by the light emitting unit 3 is transmitted to the outside of the display light-equipped transmitter 100 that is on the front side of the display light-equipped transmitter 100. In particular, the transmitting region 13 is a region through which the light that is guided by the light guide 2 is transmitted to the outside of the display light-equipped transmitter 100 that is at least on the front surface side (+Z direction) of the display light-equipped transmitter 100. For example, the transmitting region 13 is a region through which the light is transmitted to the outside of the display light-equipped transmitter 100 on the side surface side in addition to the front surface side (+Z direction). Specifically, the transmitting region 13 is a region where the transmitting layer L12 (described later) is provided and the non-transmitting layer L11 (described later) and the transmitting layer L12 do not overlap with each other (that is, the region of only the transmitting layer L12 out of the non-transmitting layer L11 and the transmitting layer L12). In addition, the transmitting region 13 is, for example, a region provided in the front surface portion 11 and the side surface portion 12. As an example, the transmitting region 13 is provided to the side surface portion 12 in FIG. 3 from the outer peripheral side of the front surface portion 11 surrounding a center side non-transmitting region 141 in FIG. 2. In addition, the transmitting region 13 is, for example, red and translucent as a whole so as to diffuse the light from the light emitting unit 3 in the entire transmitting region 13 in any color (such as red) and the transmitting region 13 as viewed from the front surface side (+Z direction) is two regions provided in an arc shape as a whole so as to surround the center side non-transmitting region 141. As an example, the transmitting region 13 includes a left transmitting region 131 and a right transmitting region 132 in FIG. 2. Here, “arc shape” is a shape that is annular as a whole via a discontinuous part (where, for example, the transmitting region 13 is not present). In other words, “arc shape” differs from so-called annular shapes and is a concept including, for example, a shape corresponding to a part of the outer periphery of a polygon or a circular arc corresponding to the shape of a part of the outer periphery of a circular shape or an elliptical shape.

The left transmitting region 131 and the right transmitting region 132 have a circular arc shape. The left transmitting region 131 and the right transmitting region 132 as viewed from the front surface side (+Z direction) are provided on the outer peripheral side of the front surface portion 11 across an upper non-transmitting region 142 and a lower non-transmitting region 143 and are provided from the outer peripheral side to a side surface side non-transmitting region 144 side of the side surface portion 12 in FIG. 3.

(Configuration-Details-Front Cover-Non-transmitting Region)

The non-transmitting region 14 in FIGS. 2 and 3 is a region through which the light that is emitted by the light emitting unit 3 is not transmitted to the outside of the display light-equipped transmitter 100 that is on the front side of the display light-equipped transmitter 100. Specifically, the non-transmitting region 14 includes the region where the non-transmitting layer L11 (described later) is provided. In particular, the non-transmitting layer L11 and the transmitting layer L12 overlap with each other in the non-transmitting region 14. In addition, the non-transmitting region 14 is, for example, a region provided in the front surface portion 11 and the side surface portion 12 and having a red outside surface. As an example, the non-transmitting region 14 includes the center side non-transmitting region 141, the upper non-transmitting region 142, the lower non-transmitting region 143, and the side surface side non-transmitting region 144.

The center side non-transmitting region 141 is provided in the front surface portion 11. Specifically, the center side non-transmitting region 141 is provided on the center side of the front surface portion 11 in the direction along the front surface portion 11 (direction along the XY plane). In addition, the upper non-transmitting region 142 is provided continuously from the center side non-transmitting region 141. Specifically, the upper non-transmitting region 142 is provided from the front surface portion 11 to the side surface portion 12 on the upper side (+Y direction) of the center side non-transmitting region 141. In addition, the lower non-transmitting region 143 is provided continuously from the center side non-transmitting region 141. Specifically, the lower non-transmitting region 143 is provided from the front surface portion 11 to the side surface portion 12 on the lower side (−Y direction) of the center side non-transmitting region 141. In addition, the side surface side non-transmitting region 144 is provided continuously from the upper non-transmitting region 142 and the lower non-transmitting region 143. Specifically, the side surface side non-transmitting region 144 is provided over the entire circumference of the side surface portion 12 as illustrated in FIG. 3.

(Configuration-Details-Front Cover-Non-transmitting Layer)

The non-transmitting layer L11 in FIG. 7 forms the outer shape of the front cover 1. Specifically, the non-transmitting layer L11 constitutes the non-transmitting region 14 and is molded of a non-transmitting material transmitting no light. In addition, the non-transmitting layer L11 is, for example, smaller in area than the transmitting layer L12 and obtained by a resin material that transmits no light being molded into an outer shape corresponding to the non-transmitting region 14 by any molding method (such as so-called two-color molding).

(Configuration-Details-Front Cover-Transmitting Layer)

The transmitting layer L12 in FIG. 7 forms the outer shape of the front cover 1. Specifically, the transmitting layer L12 constitutes the transmitting region 13 and the non-transmitting region 14, is molded of a transmitting material transmitting light, and overlaps only in part with the non-transmitting layer L11. In addition, the transmitting layer L12 is, for example, a layer overlapping with the entire non-transmitting layer L11 from the front side, larger in area than the non-transmitting layer L11, and obtained by a resin material that transmits light being molded into an outer shape corresponding to the transmitting region 13 and the non-transmitting region 14 (that is, the outer shape of the entire front cover 1) by any molding method (such as so-called two-color molding).

(Configuration-Details-Front Cover-Opening and Closing Opening Portion)

The opening and closing opening portion 15 in FIG. 5 is a communication opening and is an opening that leads to the inner portion of the display light-equipped transmitter 100. Specifically, the display light-equipped transmitter 100 is operated via the opening and closing opening portion 15, the opening and closing opening portion 15 is provided in, for example, the front surface portion 11, and the opening and closing opening portion 15 has a rectangular shape.

(Configuration-Details-Front Cover-Display Plate)

The display plate 16 in FIG. 5 is an opening and closing plate allowing the opening and closing opening portion 15 to be opened and closed. For example, the display plate 16 is provided in the front surface portion 11 and has a rectangular shape.

(Configuration-Details-Front Cover-Exposing Opening Portion)

The exposing opening portion 17 in FIG. 5 is an exposing opening exposing the protective plate 42 such that a user can press the protective plate 42. For example, the exposing opening portion 17 is provided in the front surface portion 11. As an example, the exposing opening portion 17 has a circular shape.

(Configuration-Details-Front Cover-Front Cover Side Engagement Portion)

The front cover side engagement portion 18 in FIG. 6 is an engagement unit that engages the front cover 1 with the component plate 5 and fixes the front cover 1 to the component plate 5. For example, the front cover side engagement portion 18 engages with a component plate side front cover engagement portion 51 (described later) of the component plate 5 and locks the mutual rotation of the front cover 1 and the component plate 5. In addition, two front cover side engagement portions 18 in total are provided on the upper side (+Y direction) and the lower side (−Y direction) at the edge of the back side (−Z direction) of the side surface portion 12.

(Configuration-Details-Front Cover-Front Cover Side Fixing Portion)

The front cover side fixing portion 19 in FIG. 6 fixes the front cover 1 to the component plate 5 by screwing, is a screwed unit into which a front cover fixing screw S11 is screwed, and is provided in the display light-equipped transmitter 100. For example, the front cover side fixing portion 19 is exposed to the outside of the display light-equipped transmitter 100 via the opening and closing opening portion 15 in a case where the display plate 16 is opened in a state where the front cover fixing screw S11 is not screwed and is not exposed to the outside of the display light-equipped transmitter 100 via the opening and closing opening portion 15 in a case where the display plate 16 is closed in a state where the front cover fixing screw S11 is not screwed. As an example, the front cover side fixing portion 19 is provided with a through hole through which the cover fixing screw S11 is passed.

Here, the front cover fixing screw S11 is a screwing unit that fixes the front cover 1 to the component plate 5 by screwing and is provided in the display light-equipped transmitter 100. For example, the front cover fixing screw S11 is continuously screwed into the front cover side fixing portion 19 of the front cover 1 and a component plate side front cover screwing portion 52 (described later) of the component plate 5. In addition, for example, the front cover fixing screw S11 is exposed to the outside of the display light-equipped transmitter 100 via the opening and closing opening portion 15 in a case where the display plate 16 is opened and is not exposed to the outside of the display light-equipped transmitter 100 via the opening and closing opening portion 15 in a case where the display plate 16 is closed.

(Configuration-Details-Component Plate)

The component plate 5 is provided with, for example, the component plate side front cover engagement portion 51, the component plate side front cover screwing portion 52, a first component plate side name plate portion 53, and a second component plate side name plate portion 54 illustrated in FIG. 5.

(Configuration-Details-Component Plate-Component Plate Side Front Cover Engagement Portion)

The component plate side front cover engagement portion 51 in FIG. 5 is an engagement unit that engages the front cover 1 with the component plate 5 and fixes the front cover 1 to the component plate 5. For example, the component plate side front cover engagement portion 51 engages with the front cover side engagement portion 18 of the front cover 1 and locks the mutual rotation of the front cover 1 and the component plate 5. In addition, two component plate side front cover engagement portions 51 in total are provided on the upper side (+Y direction) and the lower side (−Y direction) at the outside edge of the component plate 5.

(Configuration-Details-Component Plate-Component Plate Side Front Cover Screwing Portion)

The component plate side front cover screwing portion 52 in FIG. 5 fixes the front cover 1 to the component plate 5 by screwing and is a screwed unit into which the front cover fixing screw S11 is screwed. For example, the component plate side front cover screwing portion 52 is provided with a screw hole into which the front cover fixing screw S11 is screwed.

(Configuration-Details-Component Plate-First Component Plate Side Name Plate Portion)

The first component plate side name plate portion 53 in FIG. 5 is an inspection information display unit that displays at least first inspection information out of inspection information on the display light-equipped transmitter 100. For example, the first component plate side name plate portion 53 displays system information, address information, and operation guide information together with the first inspection information. In addition, for example, the first component plate side name plate portion 53 is provided in the display light-equipped transmitter 100, is exposed to the outside of the display light-equipped transmitter 100 via the opening and closing opening portion 15 in a case where the display plate 16 of the front cover 1 is opened, and is not exposed to the outside of the display light-equipped transmitter 100 via the opening and closing opening portion 15 in a case where the display plate 16 of the front cover 1 is closed. The first component plate side name plate portion 53 includes a seal for labeling.

Here, “inspection information” is information confirmed by an inspection worker in a case where the display light-equipped transmitter 100 is inspected. “Inspection information” can have any specific content. For example, “inspection information” is a concept including the first inspection information and second inspection information. “First inspection information” is part of the information included in the inspection information. For example, “first inspection information” is information including the model number of the display light-equipped transmitter 100, a firefighting certification number, and the rating, the date of manufacture, and the serial number of the light emitting unit 3. “Second inspection information” is other partial information constituting the information included in the inspection information. For example, “second inspection information” is label information indicating that the display light-equipped transmitter 100 has passed a fire test.

“System information” is information related to electrical connection to a disaster prevention receiver (not illustrated). For example, “system information” is information related to the section of the monitoring region where the display light-equipped transmitter 100 is provided. In addition, “address information” is information related to electrical connection to the disaster prevention receiver (not illustrated). For example, “address information” is information on an address used for communication with the disaster prevention receiver and set in the display light-equipped transmitter 100. “Disaster prevention receiver” is an external device monitoring and reporting a fire in the monitoring region. For example, “disaster prevention receiver” is a device electrically connected to at least the display light-equipped transmitter 100. In addition, “operation guide information” is operation guiding information for the display light-equipped transmitter 100. For example, “operation guide information” is procedure guiding information on the operation of the pressing spring 43 for returning the protective plate 42 in a pressed state to the original position of the protective plate 42.

All of the information can be displayed in the first component plate side name plate portion 53 by any method. For example, the model number, the firefighting certification number, and the rating of the light emitting unit 3, which are text information for inspection, are displayed along with the operation guide information at a position facing the opening and closing opening portion 15 in the thickness direction (Z direction) and the system information and the address information are displayed along with the date of manufacture and the serial number, which are text information for inspection, at a position facing the opening and closing opening portion 15 in the thickness direction (Z direction) with the importance of each information piece and the like taken into account.

(Configuration-Details-Component Plate-Second Component Plate Side Name Plate Portion)

The second component plate side name plate portion 54 is an inspection information display unit that displays at least the second inspection information out of the inspection information on the display light-equipped transmitter 100. For example, the second component plate side name plate portion 54 displays only the second inspection information. In addition, for example, the second component plate side name plate portion 54 is similar in configuration to the first component plate side name plate portion 53 except for the position and the shape of the second component plate side name plate portion 54.

(Assembly and Installation Methods)

Next, methods for assembling and installing the display light-equipped transmitter 100 will be described.

First, the light guide 2, the display light board 41, the protective plate 42, the pressing spring 43, and the switch 44 in FIG. 5 and the transmitter board 61 and the board cover 62 in FIG. 4 are attached to the component plate 5 by any fixing unit (such as screwing with a screw, engagement with an engagement structure, and fitting with a fitting structure).

Next, a part of the component plate 5 is inserted into the opening portion of the sheet metal 91 illustrated in FIG. 4. Subsequently, the component plate 5 is screwed and attached to the sheet metal 91 by means of a component plate fixing screw S12.

Next, the front cover 1 is engaged with the component plate 5. Specifically, the front cover 1 is engaged with the component plate 5 by, for example, mutual engagement between the front cover side engagement portion 18 of the front cover 1 and the component plate side front cover engagement portion 51 of the component plate 5. In this case, the mutual rotation of the front cover 1 and the component plate 5 is locked by the front cover side engagement portion 18 and the component plate side front cover engagement portion 51 and the front cover 1 is temporarily fixed to the component plate 5.

Next, the front cover 1 is fixed to the component plate 5. Specifically, for example, the front cover fixing screw S11 is screwed through the through hole of the front cover side fixing portion 19 of the front cover 1 via the opening and closing opening portion 15 and fixed by screwing into the screw hole of the component plate side front cover screwing portion 52 of the component plate 5 in a state where the display plate 16 of the front cover 1 is open. In this case, the outer peripheral side of the front cover 1 is engaged and the center side of the front cover 1 is screwed, and thus the front cover 1 is reliably fixed to the component plate 5. Especially, the fixing can be performed with the single front cover fixing screw S11, and thus screwing at a plurality of points is not necessary and the front cover 1 can be easily fixed to the component plate 5. The assembly and installation of the display light-equipped transmitter 100 are completed as a result.

(Light Emission)

Next, the light emission by the display light-equipped transmitter 100 will be described. Described here is, for example, the optical path of light in a case where the light emitting unit 3 has emitted light to the light guide 2.

First, the light emitted by the light emitting unit 3 is incident on the light guide 2 and guided to the entire light guide 2. Subsequently, the light guided by the light guide 2 is output to the outside of the display light-equipped transmitter 100 that is on the front side of the display light-equipped transmitter 100 via the transmitting region 13 of the front cover 1. In this case in particular, light emission is possible from the side surface portion 12 as well as the front surface portion 11 since the transmitting region 13 in FIG. 3 is provided in the side surface portion 12 as well as the front surface portion 11 of the front cover 1 as described above, and thus a user can visually recognize and confirm from every position on the front side of the display light-equipped transmitter 100 that a part of the display light-equipped transmitter 100 emits light in red.

(Notification Operation)

A notification operation will be described below. The display light-equipped transmitter 100 provides notification of the outbreak of a fire by means of the notification operation. Described here is, for example, a notification operation in a case where a user has pressed the protective plate 42 via the exposing opening portion 17. This notification operation is similar to the notification operation in the related art, and thus only the outline of the notification operation will be described below.

In a case where a user presses the protective plate 42 via the exposing opening portion 17, the switch 44 is pressed together with the protective plate 42. As a result, the electric circuit of the transmitter board 61 provides notification by transmitting a fire notification signal, which is a signal for fire notification, to the disaster prevention receiver via a communication line (not illustrated). The notification operation is performed in this manner.

(Effect of Shape of Transmitting Region)

As described above, the transmitting region 13 illustrated in FIG. 2 is provided with the two-circular arc-shaped left transmitting region 131 and right transmitting region 132 in the lateral direction (X direction). As a result, the display light-equipped transmitter 100 can be more conspicuous than in the case of single-point light emission by means of light emission at a plurality of points and it is possible to reliably meet predetermined standards requiring the lateral (X-direction) visibility of the display light-equipped transmitter 100 (such as standards related to the Fire Services Act).

In addition, the upper non-transmitting region 142 and the lower non-transmitting region 143 face the light emitting unit 3 in the front cover 1 illustrated in FIG. 2. Accordingly, light blocking can be performed in the regions where mottles in terms of the state of light emission are likely to result from an increase in the light quantity of the light emitting unit 3 by means of light blocking in the regions facing the light emitting unit 3, and thus it is possible to cause the entire transmitting region 13 of the front cover 1 to emit light with uniformity and improve the design of the entire display light-equipped transmitter 100 including the transmitting region 13 emitting light. Especially, the region that faces the upper non-transmitting region 142 and the lower non-transmitting region 143 in the display light-equipped transmitter 100 can be used for the light emitting unit 3 to be provided, and thus the region where the light emitting unit 3 is provided can be concentrated in two places. As a result, the display light-equipped transmitter 100 can be compact by means of an effective use of the internal space of the display light-equipped transmitter 100.

### Effect of Embodiment 1

In the present embodiment, the transmitting region 13 and the non-transmitting region 14 of the front cover 1 are configured integrally with each other as described above. Accordingly, no gap or the like is provided between the transmitting region 13 and the non-transmitting region 14, and thus it is possible to prevent a contaminant such as rain and dust from entering the display light-equipped transmitter 100. In addition, for example, it is possible to give an impression of unity and integrity with regard to the entire front cover 1, and thus the design of the display light-equipped transmitter 100 can be improved.

In addition, in the transmitting region 13, the transmitting layer L12 is provided with the non-transmitting layer L11 and the transmitting layer L12 not overlapping with each other. The non-transmitting region 14 is a region including a region where the non-transmitting layer L11 and the transmitting layer L12 overlap with each other. As a result, the functions of the transmitting region 13 and the non-transmitting region 14 can be reliably ensured by, for example, the transmitting layer L12 and the non-transmitting layer L11 being used, and thus the shape of the transmitting region 13 can be conspicuous with light in the display light-equipped transmitter 100 and the position of the display light-equipped transmitter 100 can be reliably displayed. In addition, for example, the transmitting layer L12 can be provided in both the transmitting region 13 and the non-transmitting region 14, and thus the display light-equipped transmitter 100 can be coated with the transmitting layer L12 and a sense of luxury can be produced for the display light-equipped transmitter 100.

In addition, by the front cover side engagement portion 18 and the component plate side front cover engagement portion 51 that engage the front cover 1 with the component plate 5 being provided, the front cover 1 and the component plate 5 can be, for example, temporarily fixed to each other. As a result, it is possible to provide the display light-equipped transmitter 100 that is assembled with ease.

The front cover fixing screw S11 fixing the front cover 1 to the component plate 5 by screwing is exposed to the outside of the display light-equipped transmitter 100 via the opening and closing opening portion 15 in a case where the display plate 16 is opened and is not exposed to the outside of the display light-equipped transmitter 100 via the opening and closing opening portion 15 in a case where the display plate 16 is closed. Accordingly, it is possible, for example, to operate the front cover fixing screw S11 by opening the display plate 16 or hide the front cover fixing screw S11 by closing the display plate 16, and thus the assembly can be further facilitated with the design of the display light-equipped transmitter 100 maintained. In addition, in a case where, for example, the front cover fixing screw S11 is provided in addition to the front cover side engagement portion 18 and the component plate side front cover engagement portion 51 described above, the front cover 1 and the component plate 5 can be fixed to each other by the front cover fixing screw S11 with the mutual rotation of the front cover 1 and the component plate 5 locked by the front cover side engagement portion 18 and the component plate side front cover engagement portion 51, and thus the display light-equipped transmitter 100 can be assembled with ease.

### Embodiment 2

Next, Embodiment 2 will be described. Described in this embodiment is a case where the display light-equipped transmitter is attached from the front surface side of the attachment target.

(Configuration)

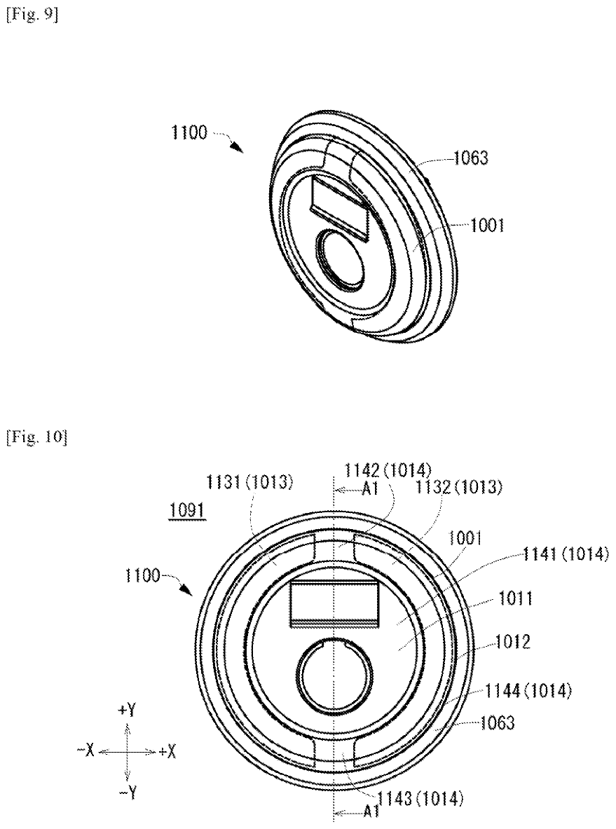

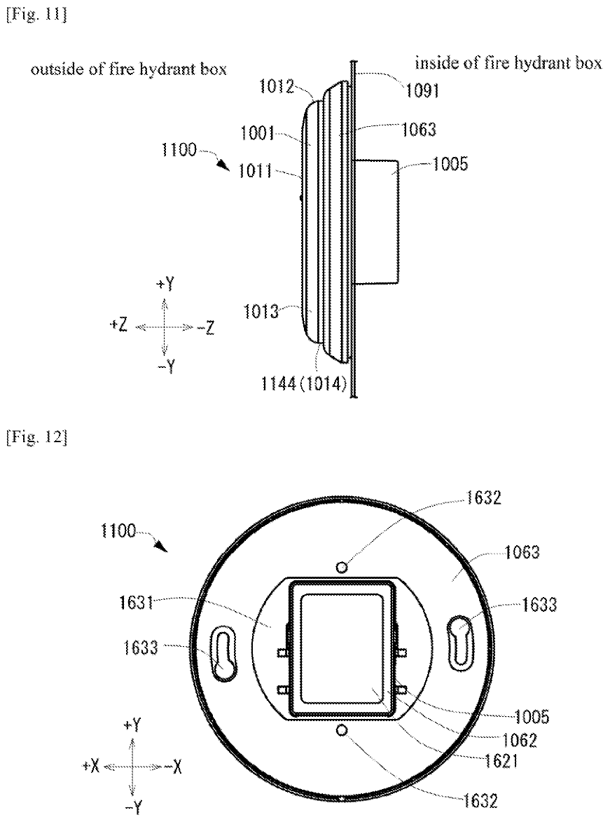

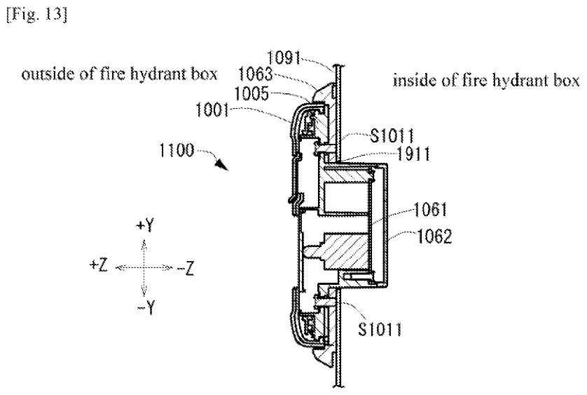

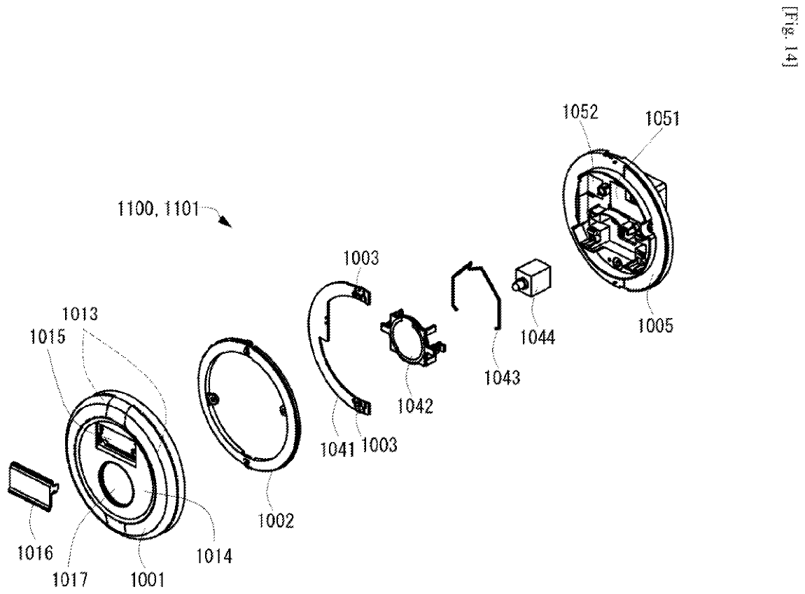

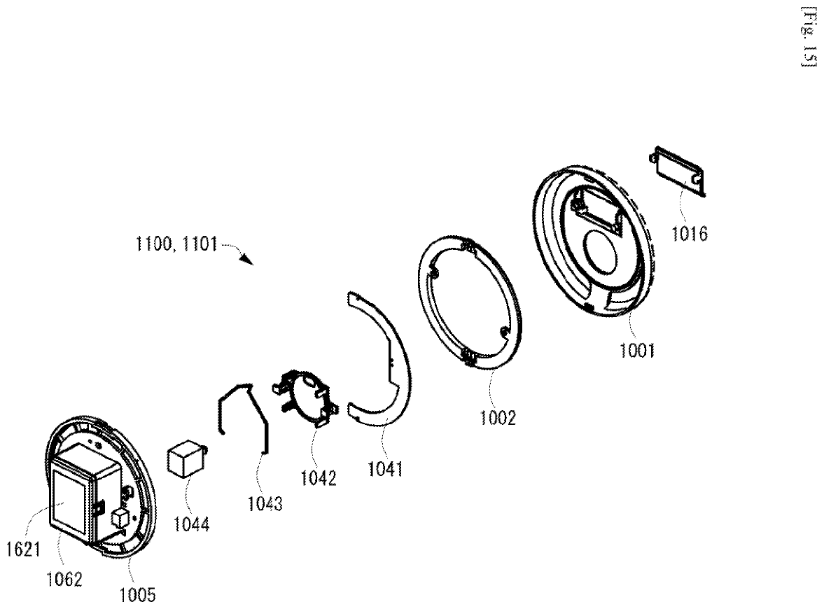

The configuration of the display light-equipped transmitter according to the present embodiment will be described first. FIG. 9 is a perspective view of the display light-equipped transmitter according to the present embodiment. FIG. 10 is a front view of the display light-equipped transmitter. FIG. 11 is a side view of the display light-equipped transmitter. FIG. 12 is a rear view of the display light-equipped transmitter. FIG. 13 is a cross-sectional view taken along the Al-Al arrow in FIG. 10. FIG. 14 is an exploded perspective view of a part of the display light-equipped transmitter as viewed from the front surface side. FIG. 15 is an exploded perspective view of a part of the display light-equipped transmitter as viewed from the back side. A state of being attached to a sheet metal 1091 is illustrated in FIGS. 10, 11, and 13. In the side view of FIG. 11, the configuration of the inner portion of a fire hydrant box is also indicated by a solid line for convenience of description although the inner portion of the fire hydrant box is actually invisible (the same applies to the side view of Embodiment 3). In the following description, the X-Y-Z directions illustrated in FIGS. 10 to 13 are mutually orthogonal. Specifically, the Y direction is a vertical direction and the X direction and the Z direction are horizontal directions orthogonal to the vertical direction. For example, the Y direction will be referred to as up-down direction, the +Y direction will be referred to as upper side, the −Y direction will be referred to as lower side, the X direction will be referred to as left-right direction, the +X direction will be referred to as right side, the −X direction will be referred to as left side, the Z direction will be referred to as thickness direction, the +Z direction will be referred to as front surface side, and the −Z direction will be referred to as back side or rear surface side. In the following description, terms relating to “X-Y-Z directions” are convenient expressions for describing the relative positional relationships (or the directions) of components and the like in an illustrated display light-equipped transmitter 1100 with the directions that are along the XY plane (that is, the directions including the +X, −X, +Y, and −Y directions) referred to as side surface side and the direction including the side surface side and the front surface side referred to as front side. Hereinafter, details of particularly characteristic configurations will be described after the configuration of the display light-equipped transmitter 1100 as a whole is described (the same applies to each drawing of Embodiment 3).

The display light-equipped transmitter 1100 illustrated in each of the drawings is a notification unit that provides notification of an abnormality in a monitoring region. Specifically, the display light-equipped transmitter 1100 is a device providing notification of the outbreak of a fire in the monitoring region. The display light-equipped transmitter 1100 is attached to the sheet metal 1091 of a fire hydrant box from the front side as illustrated in FIG. 13. The display light-equipped transmitter 1100 is provided with, for example, a front cover 1001, a light guide 1002, light emitting units 1003, a display light board 1041, a protective plate 1042, a pressing spring 1043, a switch 1044, and a component plate 1005 illustrated in FIG. 14 and a transmitter board 1061, a board cover 1062, and an attachment adapter 1063 illustrated in FIG. 13.

(Configuration-Front Cover)

The front cover 1001 is a cover unit that covers at least the light emitting unit 1003 from the front side. For example, a transmitting region 1013 and a non-transmitting region 1014 in FIG. 14, which will be described later, are configured integrally with each other in the front cover 1001. In addition, the front cover 1001 has a disk-shaped outer shape as a whole. The front cover 1001 will be described in detail later.

(Configuration-Light Guide)

The light guide 1002 is a light guiding unit that guides the light that is emitted by the light emitting unit 1003. Specifically, the light guide 1002 is provided along the front cover 1001 over the entire transmitting region 1013. The light guide 1002 can be of any specific type and configuration. For example, the light guide 1002 is provided between the front cover 1001 and the display light board 1041 in the thickness direction (Z direction), is annularly formed so as to surround the switch 1044, has an annular shape, and is formed of any light guiding material (such as a transparent resin material).

(Configuration-Light Emitting Unit)

The light emitting unit 1003 is a light emitting unit that emits light. Specifically, the light emitting unit 1003 emits light toward the light guide 1002. The light emitting unit 1003 can be of any specific type and configuration. For example, the light emitting units 1003 are light emitting diodes mounted on the display light board 1041 and provided at positions close to the upper side (+Y direction) and the lower side (−Y direction) in the display light-equipped transmitter 1100.

(Configuration-Display Light Board)

The display light board 1041 is a circuit board on which the light emitting unit 1003 is mounted. Specifically, the display light board 1041 is provided on the side that is opposite to the front cover 1001 with respect to the light guide 1002. The display light board 1041 can be of any specific type and configuration. For example, the display light board 1041 is configured to connect the positions of the light emitting units 1003 while avoiding the switch 1044 and is configured in a circular arc shape facing only a part of the left side (−X direction) of the light guide 1002.

(Configuration-Protective Plate)

The protective plate 1042 is an operation unit that operates the display light-equipped transmitter 1100. Specifically, the protective plate 1042 is for protecting the switch 1044 and is pressed by a user in the event of an abnormality. The protective plate 1042 can be of any specific type and configuration. For example, the protective plate 1042 is provided so as to be partially exposed via an exposing opening portion 1017 of the front cover 1001.

(Configuration-Pressing Spring)

The pressing spring 1043 is an operation unit that operates the display light-equipped transmitter 1100. Specifically, the pressing spring 1043 is operated by a user so that the protective plate 1042 in a pressed state returns to the original position of the protective plate 1042. The pressing spring 1043 can be of any specific type and configuration. For example, the pressing spring 1043 is bent so as to be provided around the switch 1044.

(Configuration-Switch)

The switch 1044 is an operation unit that operates the display light-equipped transmitter 1100. Specifically, the switch 1044 is provided on the center side of the display light-equipped transmitter 1100 in the direction along a front surface portion 1011 of the front cover 1001 and is pressed via the protective plate 1042 and by a user in the event of an abnormality. The switch 1044 can be of any specific type and configuration. For example, the switch 1044 can be configured as a push button switch.

(Configuration-Component Plate)

The component plate 1005 is a cover unit that covers at least the light emitting unit 1003 from the back side (−Z direction). For example, the component plate 1005 is resinous and is a back cover that is circular as a whole. The component plate 1005 will be described in detail later.

(Configuration-Transmitter Board)

The transmitter board 1061 in FIG. 13 is a transmitter circuit board on which an electric circuit for operating the display light-equipped transmitter 1100 is mounted. The transmitter board 1061 can be of any specific type and configuration. For example, the transmitter board 1061 has a rectangular shape as a whole and is fixed to the back side of the component plate 1005 by any method (such as screwing with a screw).

(Configuration-Board Cover)

The board cover 1062 is a cover unit that covers the transmitter board 1061 from the back side (−Z direction). For example, the board cover 1062 has a rectangular shape as a whole and is engaged with and attached to the component plate 1005. The board cover 1062 will be described in detail later.

(Configuration-Attachment Adapter)

The attachment adapter 1063 is an attachment unit provided between the sheet metal 1091 and the component plate 1005 and is an attachment unit that attaches the component plate 1005 to the sheet metal 1091. For example, the attachment adapter 1063 is red and has a disk shape larger in diameter than the component plate 1005 as a whole. The attachment adapter 1063 will be described in detail later.

(Configuration-Details)

Next, details of the front cover 1001, the component plate 1005, the board cover 1062, and the attachment adapter 1063 will be described.

(Configuration-Details-Front Cover)

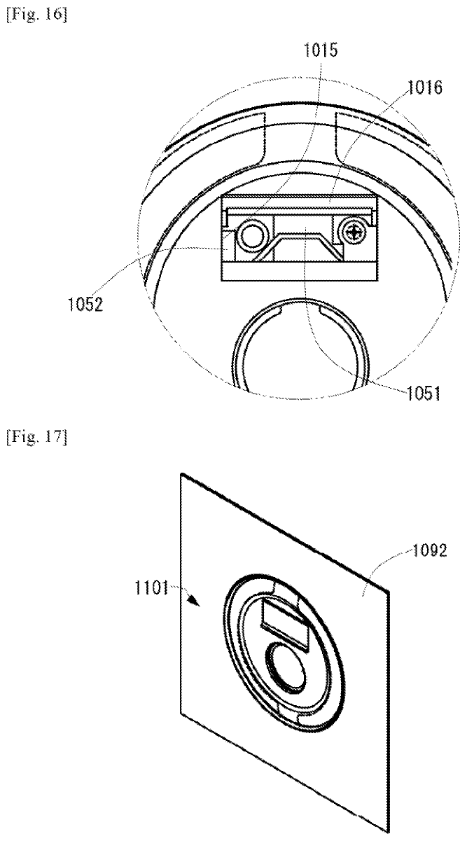

FIG. 16 is a diagram in which FIG. 10 is enlarged in part and illustrates a state where a display plate is open. The front cover 1001 illustrated in FIGS. 10 and 11 is provided with the front surface portion 1011, a side surface portion 1012, the transmitting region 1013, the non-transmitting region 1014, and an opening and closing opening portion 1015, a display plate 1016, and the exposing opening portion 1017 illustrated in FIG. 14.

(Configuration-Front Cover-Front Surface Portion)

The front surface portion 1011 in FIGS. 10 and 11 covers the light emitting unit 1003 from the front surface side (+Z direction) of the display light-equipped transmitter 1100 and constitutes a part of the outer shape of the front cover 1001. For example, the front surface portion 1011 is circular and along the XY plane, continues to the side surface portion 1012 with the outside edge of the front surface portion 1011 slightly curved, and is configured integrally with the side surface portion 1012.

(Configuration-Details-Front Cover-Side Surface Portion)

The side surface portion 1012 in FIGS. 10 and 11 covers the light emitting unit 1003 from the side surface side of the display light-equipped transmitter 1100 and constitutes another part of the outer shape of the front cover 1001. For example, the side surface portion 1012 is partially curved from the outside edge of the front surface portion 1011, extends toward the back side (−Z direction), continues from the front surface portion 1011, and is configured integrally with the front surface portion 1011.

(Configuration-Details-Front Cover-Transmitting Region)

The transmitting region 1013 in FIGS. 10 and 11 is a region through which the light that is emitted by the light emitting unit 1003 is transmitted to the outside of the display light-equipped transmitter 1100 that is on the front side of the display light-equipped transmitter 1100. In particular, the transmitting region 1013 is a region through which the light that is guided by the light guide 1002 is transmitted to the outside of the display light-equipped transmitter 1100 that is at least on the front surface side (+Z direction) of the display light-equipped transmitter 1100. For example, the transmitting region 1013 is a region through which the light is transmitted to the outside of the display light-equipped transmitter 1100 on the side surface side in addition to the front surface side (+Z direction). In addition, the transmitting region 1013 is, for example, a region provided in the front surface portion 1011 and the side surface portion 1012. As an example, the transmitting region 1013 is provided to the side surface portion 1012 in FIG. 11 from the outer peripheral side of the front surface portion 1011 surrounding a center side non-transmitting region 1141 in FIG. 10. In addition, the transmitting region 1013 is, for example, red and translucent as a whole so as to diffuse the light from the light emitting unit 1003 in the entire transmitting region 1013 in any color (such as red) and the transmitting region 1013 as viewed from the front surface side (+Z direction) is two regions provided in an arc shape as a whole so as to surround the center side non-transmitting region 1141. As an example, the transmitting region 1013 includes a left transmitting region 1131 and a right transmitting region 1132 in FIG. 10. Here, “arc shape” is a shape that is annular as a whole via a discontinuous part (where, for example, the transmitting region 1013 is not present). In other words, “arc shape” differs from so-called annular shapes and is a concept including, for example, a shape corresponding to a part of the outer periphery of a polygon or a circular arc corresponding to the shape of a part of the outer periphery of a circular shape or an elliptical shape.

The left transmitting region 1131 and the right transmitting region 1132 have a circular arc shape. The left transmitting region 1131 and the right transmitting region 1132 as viewed from the front surface side (+Z direction) are provided on the outer peripheral side of the front surface portion 1011 across an upper non-transmitting region 1142 and a lower non-transmitting region 1143 and are provided from the outer peripheral side to a side surface side non-transmitting region 1144 side of the side surface portion 1012 in FIG. 11.

(Configuration-Details-Front Cover-Non-transmitting Region)

The non-transmitting region 1014 in FIGS. 10 and 11 is a region through which the light that is emitted by the light emitting unit 1003 is not transmitted to the outside of the display light-equipped transmitter 1100 that is on the front side of the display light-equipped transmitter 1100. For example, the non-transmitting region 1014 is a region provided in the front surface portion 1011 and the side surface portion 1012 and having a red outside surface. As an example, the non-transmitting region 1014 includes the center side non-transmitting region 1141, the upper non-transmitting region 1142, the lower non-transmitting region 1143, and the side surface side non-transmitting region 1144.

The center side non-transmitting region 1141 is provided in the front surface portion 1011. Specifically, the center side non-transmitting region 1141 is provided on the center side of the front surface portion 1011 in the direction along the front surface portion 1011 (direction along the XY plane). In addition, the upper non-transmitting region 1142 is provided continuously from the center side non-transmitting region 1141. Specifically, the upper non-transmitting region 1142 is provided from the front surface portion 1011 to the side surface portion 1012 on the upper side (+Y direction) of the center side non-transmitting region 1141. In addition, the lower non-transmitting region 1143 is provided continuously from the center side non-transmitting region 1141. Specifically, the lower non-transmitting region 1143 is provided from the front surface portion 1011 to the side surface portion 1012 on the lower side (−Y direction) of the center side non-transmitting region 1141. In addition, the side surface side non-transmitting region 1144 is provided continuously from the upper non-transmitting region 1142 and the lower non-transmitting region 1143. Specifically, the side surface side non-transmitting region 1144 is provided over the entire circumference of the side surface portion 1012 as illustrated in FIG. 11.

Any molding method can be applied to the outer shape of the front cover 1001 including the transmitting region 1013 and the non-transmitting region 1014. Examples include so-called two-color molding by means of a resin material transmitting light and a resin material transmitting no light.

(Configuration-Details-Front Cover-Opening and Closing Opening Portion)

The opening and closing opening portion 1015 in FIG. 14 is a communication opening and is an opening that leads to the inner portion of the display light-equipped transmitter 1100. Specifically, the display light-equipped transmitter 1100 is operated via the opening and closing opening portion 1015, the opening and closing opening portion 1015 is provided in, for example, the front surface portion 1011, and the opening and closing opening portion 1015 has a rectangular shape.

(Configuration-Details-Front Cover-Display Plate)

The display plate 1016 in FIG. 14 is an opening and closing plate allowing the opening and closing opening portion 1015 to be opened and closed. For example, the display plate 1016 is provided in the front surface portion 1011 and has a rectangular shape.

(Configuration-Details-Front Cover-Exposing Opening Portion)

The exposing opening portion 1017 in FIG. 14 is an exposing opening exposing the protective plate 1042 such that a user can press the protective plate 1042. For example, the exposing opening portion 1017 is provided in the front surface portion 1011. As an example, the exposing opening portion 1017 has a circular shape.

(Configuration-Details-Board Cover)

The board cover 1062 is provided with, for example, a board cover side name plate portion 1621 illustrated in FIG. 15.

(Configuration-Details-Board Cover-Board Cover Side Name Plate Portion)

The board cover side name plate portion 1621 in FIG. 15 is a connection-related information display unit that displays connection-related information. Specifically, the board cover side name plate portion 1621 is provided so as to be exposed to the outside of the display light-equipped transmitter 1100 on the back side (−Z direction) of the display light-equipped transmitter 1100. For example, the board cover side name plate portion 1621 is a seal affixed to the board cover 1062.

Here, “connection-related information” is information related to electrical connection between the display light-equipped transmitter 1100 and a disaster prevention receiver (not illustrated). “Connection-related information” is a concept including, for example, terminal information, address information (described later), and system information (described later). “Terminal information” is information for specifying a terminal provided in the display light-equipped transmitter 1100 and electrically connected to the disaster prevention receiver (not illustrated).

(Configuration-Details-Component Plate)

The component plate 1005 is provided with, for example, a first component plate side name plate portion 1051 and a second component plate side name plate portion 1052 illustrated in FIG. 14.

(Configuration-Details-Component Plate-First Component Plate Side Name Plate Portion)

The first component plate side name plate portion 1051 in FIG. 14 is an inspection information display unit that displays at least first inspection information out of inspection information on the display light-equipped transmitter 1100. For example, the first component plate side name plate portion 1051 displays the system information, the address information, and operation guide information together with the first inspection information. In addition, for example, the first component plate side name plate portion 1051 is provided in the display light-equipped transmitter 1100, is exposed to the outside of the display light-equipped transmitter 1100 via the opening and closing opening portion 1015 in a case where the display plate 1016 of the front cover 1001 is opened, and is not exposed to the outside of the display light-equipped transmitter 1100 via the opening and closing opening portion 1015 in a case where the display plate 1016 of the front cover 1001 is closed. In addition, the first component plate side name plate portion 1051 includes a seal for labeling.

Here, “inspection information” is information confirmed by an inspection worker in a case where the display light-equipped transmitter 1100 is inspected. “Inspection information” can have any specific content. For example, “inspection information” is a concept including the first inspection information and second inspection information. “First inspection information” is part of the information included in the inspection information. For example, “first inspection information” is information including the model number of the display light-equipped transmitter 1100, a firefighting certification number, and the rating, the date of manufacture, and the serial number of the light emitting unit 1003. “Second inspection information” is other partial information constituting the information included in the inspection information. For example, “second inspection information” is label information indicating that the display light-equipped transmitter 1100 has passed a fire test.

“System information” is information related to electrical connection to the disaster prevention receiver (not illustrated). For example, “system information” is information related to the section of the monitoring region where the display light-equipped transmitter 1100 is provided. In addition, “address information” is information related to electrical connection to the disaster prevention receiver (not illustrated). For example, “address information” is information on an address used for communication with the disaster prevention receiver and set in the display light-equipped transmitter 1100. “Disaster prevention receiver” is an external device monitoring and reporting a fire in the monitoring region. For example, “disaster prevention receiver” is a device electrically connected to at least the display light-equipped transmitter 1100. In addition, “operation guide information” is operation guiding information for the display light-equipped transmitter 1100. For example, “operation guide information” is procedure guiding information on the operation of the pressing spring 1043 for returning the protective plate 1042 in a pressed state to the original position of the protective plate 1042.

All of the information can be displayed in the first component plate side name plate portion 1051 by any method. For example, the model number, the firefighting certification number, and the rating of the light emitting unit 1003, which are text information for inspection, are displayed along with the operation guide information at a position facing the opening and closing opening portion 1015 in the thickness direction (Z direction) and the system information and the address information are displayed along with the date of manufacture and the serial number, which are text information for inspection, at a position facing the opening and closing opening portion 1015 in the thickness direction (Z direction) with the importance of each information piece and the like taken into account.

(Configuration-Details-Component Plate-Second Component Plate Side Name Plate Portion)

The second component plate side name plate portion 1052 is an inspection information display unit that displays at least the second inspection information out of the inspection information on the display light-equipped transmitter 1100. For example, the second component plate side name plate portion 1052 displays only the second inspection information. In addition, for example, the second component plate side name plate portion 1052 is similar in configuration to the first component plate side name plate portion 1051 except for the position and the shape of the second component plate side name plate portion 1052.

(Configuration-Details-Attachment Adapter)

The attachment adapter 1063 is provided with, for example, an adapter side opening portion 1631, component plate screwing holes 1632, and sheet metal screwing holes 1633 illustrated in FIG. 12.

(Configuration-Details-Attachment Adapter-Adapter Side Opening Portion)

The adapter side opening portion 1631 is an opening through which a part of the component plate 1005 is inserted. For example, the adapter side opening portion 1631 is an opening through which a part of the component plate 1005 protruding to the back side (−Z direction) is inserted and is provided in the vicinity of the center of the attachment adapter 1063.

(Configuration-Details-Attachment Adapter-Screwing Hole)

The component plate screwing hole 1632 is a screwing hole for attaching the component plate 1005 to the attachment adapter 1063. The sheet metal screwing hole 1633 is a screwing hole for attaching the attachment adapter 1063 to the sheet metal 1091.

(Assembly and Installation Methods)

Next, methods for assembling and installing the display light-equipped transmitter 1100 will be described.

First, the attachment adapter 1063 illustrated in FIG. 13 is attached to the sheet metal 1091 by any specific method. For example, the attachment is performed by an attachment adapter fixing screw (not illustrated) being continuously screwed into the sheet metal screwing hole 1633 in FIG. 12 and the sheet metal 1091 in a state where the adapter side opening portion 1631 in FIG. 12 is aligned with a sheet metal side opening portion 1911 for front side attachment in FIG. 13. The sheet metal side opening portion 1911 for front side attachment is an opening for attaching the display light-equipped transmitter 1100 from the front side of the sheet metal 1091. For example, the sheet metal side opening portion 1911 for front side attachment is an opening through which a part of the component plate 1005 protruding to the back side (−Z direction) is inserted.

Next, the component plate 1005 in FIG. 13 is attached to the attachment adapter 1063 by any specific method. For example, the attachment is performed by a component plate fixing screw S1011 being continuously screwed into the component plate 1005 and the component plate screwing hole 1632 illustrated in FIG. 12.

Next, the remaining components of the display light-equipped transmitter 1100 illustrated in FIG. 14 are attached to the component plate 1005 by any fixing unit (such as screwing with a screw, engagement with an engagement structure, and fitting with a fitting structure). The assembly and installation of the display light-equipped transmitter 1100 are completed as a result.

(Light Emission)

Next, the light emission by the display light-equipped transmitter 1100 will be described. Described here is, for example, the optical path of light in a case where the light emitting unit 1003 has emitted light to the light guide 1002.

First, the light emitted by the light emitting unit 1003 is incident on the light guide 1002 and guided to the entire light guide 1002. Subsequently, the light guided by the light guide 1002 is output to the outside of the display light-equipped transmitter 1100 that is on the front side of the display light-equipped transmitter 1100 via the transmitting region 1013 of the front cover 1001. In this case in particular, light emission is possible from the side surface portion 1012 as well as the front surface portion 1011 since the transmitting region 1013 in FIG. 11 is provided in the side surface portion 1012 as well as the front surface portion 1011 of the front cover 1001 as described above, and thus a user can visually recognize and confirm from every position on the front side of the display light-equipped transmitter 1100 that a part of the display light-equipped transmitter 1100 emits light in red.

(Notification Operation)

A notification operation will be described below. The display light-equipped transmitter 1100 provides notification of the outbreak of a fire by means of the notification operation. Described here is, for example, a notification operation in a case where a user has pressed the protective plate 1042 via the exposing opening portion 1017. This notification operation is similar to the notification operation in the related art, and thus only the outline of the notification operation will be described below.

In a case where a user presses the protective plate 1042 via the exposing opening portion 1017, the switch 1044 is pressed together with the protective plate 1042. As a result, the electric circuit of the transmitter board 1061 provides notification by transmitting a fire notification signal, which is a signal for fire notification, to the disaster prevention receiver via a communication line (not illustrated). The notification operation is performed in this manner.

(Effect of Shape of Transmitting Region)

As described above, the transmitting region 1013 illustrated in FIG. 10 is provided with the two-circular arc-shaped left transmitting region 1131 and right transmitting region 1132 in the lateral direction (X direction). As a result, the display light-equipped transmitter 1100 can be more conspicuous than in the case of single-point light emission by means of light emission at a plurality of points and it is possible to reliably meet predetermined standards requiring the lateral (X-direction) visibility of the display light-equipped transmitter 1100 (such as standards related to the Fire Services Act).

In addition, the upper non-transmitting region 1142 and the lower non-transmitting region 1143 face the light emitting unit 1003 in the front cover 1001 illustrated in FIG. 10. Accordingly, light blocking can be performed in the regions where mottles in terms of the state of light emission are likely to result from an increase in the light quantity of the light emitting unit 1003 by means of light blocking in the regions facing the light emitting unit 1003, and thus it is possible to cause the entire transmitting region 1013 of the front cover 1001 to emit light with uniformity and improve the design of the entire display light-equipped transmitter 1100 including the transmitting region 1013 emitting light. Especially, the region that faces the upper non-transmitting region 1142 and the lower non-transmitting region 1143 in the display light-equipped transmitter 1100 can be used for the light emitting unit 1003 to be provided, and thus the region where the light emitting unit 1003 is provided can be concentrated in two places. As a result, the display light-equipped transmitter 1100 can be compact by means of an effective use of the internal space of the display light-equipped transmitter 1100.

### Effect of Embodiment 2

In the present embodiment, the transmitting region 1013 is provided in the front surface portion 1011 and the side surface portion 1012 as described above. Accordingly, it is possible, for example, to emit the light of the light emitting unit 1003 to both the front surface portion 1011 side and the side surface portion 1012 side, and thus users on the front and side surface sides of the display light-equipped transmitter 1100 can visually recognize the light and reliably recognize the position of the display light-equipped transmitter 1100.

In addition, the transmitting region 1013 is provided from the outer peripheral side of the front surface portion 1011 surrounding the center side non-transmitting region 1141 to the side surface portion 1012. Accordingly, for example, light can be continuously emitted from the front surface portion 1011 to the side surface portion 1012, and thus a user on a diagonal side between the front and side surface sides as well as users on the front and side surface sides of the display light-equipped transmitter 1100 can visually recognize light. As a result, users can further reliably recognize the position of the display light-equipped transmitter 1100.

In addition, the attachment adapter 1063 attaching the component plate 1005 to the sheet metal 1091 is provided between the sheet metal 1091 and the component plate 1005. Accordingly, for example, the display light-equipped transmitter 1100 can be attached from the front surface side to the sheet metal 1091, and thus no work is necessary on the back side of the sheet metal 1091 and the workability of the display light-equipped transmitter 1100 can be improved. In addition, for example, the amount of protrusion of the display light-equipped transmitter 1100 with respect to the sheet metal 1091 can be increased, and thus the visibility of the display light-equipped transmitter 1100 can be improved.

In addition, the first component plate side name plate portion 1051 and the second component plate side name plate portion 1052 displaying the inspection information are exposed to the outside of the display light-equipped transmitter 1100 in a case where the display plate 1016 is opened and are not exposed to the outside of the display light-equipped transmitter 1100 in a case where the display plate 1016 is closed. Accordingly, for example, the first component plate side name plate portion 1051 and the second component plate side name plate portion 1052 can be exposed only when necessary, and thus the inspection information can be visually recognized in a state where the appearance of the display light-equipped transmitter 1100 is kept simple and the inspection information can be displayed in a state where the design is maintained. As for previously proposed techniques for retrofitting a retrofit display light device into an existing transmitter in particular, inspection information is provided at a position that can be visually recognized only after the retrofit display light device is removed from the transmitter, and thus the retrofit display light device needs to be removed for inspection information confirmation and the removal is troublesome. In the case of the present application, however, the inspection information can be easily confirmed without the display light-equipped transmitter 1100 being removed or disassembled from the sheet metal 1091.

### Embodiment 3

Next, Embodiment 3 will be described. Described in this embodiment is a case where the display light-equipped transmitter is attached from the back side of the attachment target. Embodiment 3 is substantially identical in configuration to Embodiment 2 unless otherwise stated. The same reference numerals as those used in Embodiment 2 are attached, as needed and without redundant description, to substantially identical configurations.

(Configuration)

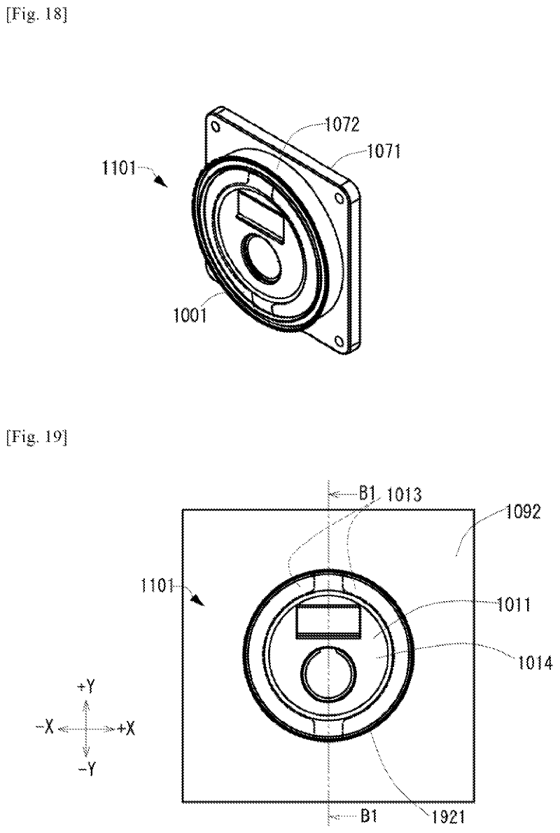

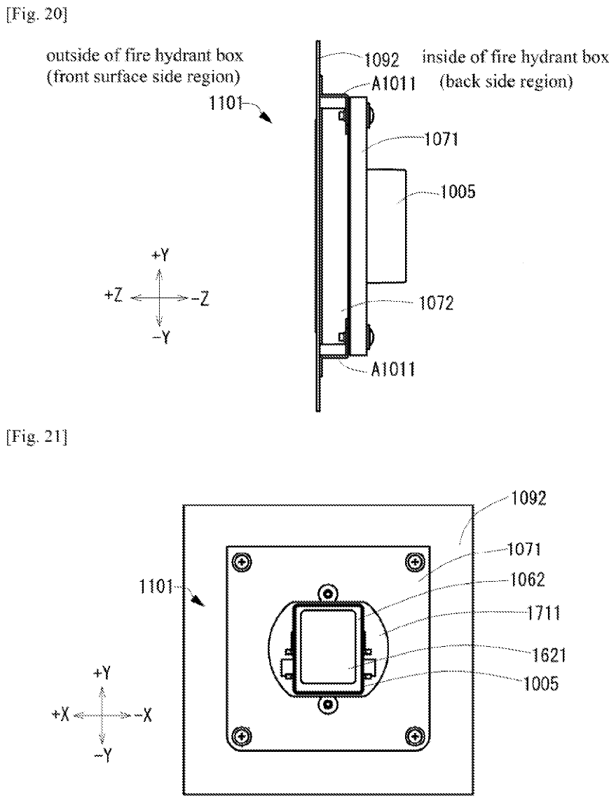

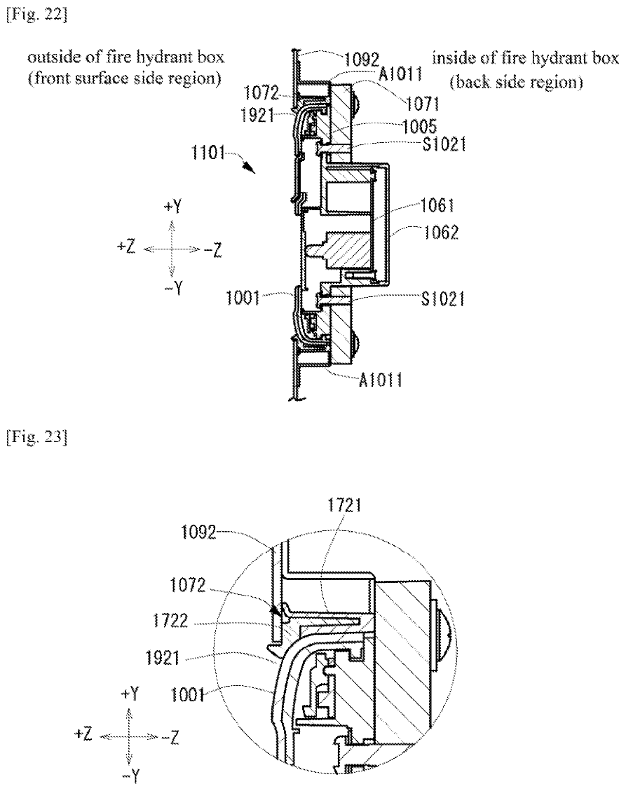

The configuration of the display light-equipped transmitter according to the present embodiment will be described first. FIG. 17 is a perspective view of the display light-equipped transmitter that is attached to the sheet metal according to the present embodiment. FIG. 18 is a perspective view of the display light-equipped transmitter that is removed from the sheet metal. FIG. 19 is a front view of the display light-equipped transmitter. FIG. 20 is a side view of the display light-equipped transmitter. FIG. 21 is a rear view of the display light-equipped transmitter. FIG. 22 is a cross-sectional view taken along the B1-B1 arrow in FIG. 19. A state of being attached to a sheet metal 1092 is illustrated in FIGS. 17 and 19 to 22. The sheet metal 1092 is illustrated as having a rectangular shape for convenience of description.

A display light-equipped transmitter 1101 illustrated in each of the drawings is attached to the sheet metal 1092 of a fire hydrant box from the back side (−Z direction) as illustrated in FIG. 22. The display light-equipped transmitter 1101 is provided with, for example, the front cover 1001, the light guide 1002, the light emitting unit 1003, the display light board 1041, the protective plate 1042, the pressing spring 1043, the switch 1044, and the component plate 1005 illustrated in FIG. 14 and the transmitter board 1061, the board cover 1062, an attachment member 1071, and a cover packing 1072 illustrated in FIG. 22.

Here, the sheet metal 1092 is an attachment target similar to the sheet metal 1091 of Embodiment 2. Specifically, the sheet metal 1092 is a sheet metal of a fire hydrant box (overall configuration not illustrated) provided in the monitoring region. For example, the sheet metal 1092 partitions a front surface side region and a back side region from each other and is provided with a sheet metal side opening portion 1921 for back side attachment illustrated in FIGS. 19 and 22. “Front surface side region” is a partial region included in the monitoring region. Specifically, “front surface side region” is a region partitioned by the sheet metal 1092 and is a region on the front surface side (+Z direction) of the display light-equipped transmitter 1101 (that is, on the front surface side (+Z direction) of the sheet metal 1092). For example, “front surface side region” is a region outside the fire hydrant box. In addition, “back side region” is another partial region included in the monitoring region. Specifically, “back side region” is a region partitioned by the sheet metal 1092 and is a region on the back side (−Z direction) of the display light-equipped transmitter 1101 (that is, on the back side (−Z direction) of the sheet metal 1092). For example, “back side region” is a region in the fire hydrant box.

In addition, the sheet metal side opening portion 1921 for back side attachment is an opening provided in the sheet metal 1092. Specifically, the sheet metal side opening portion 1921 for back side attachment is an exposing hole for exposing at least a part of the display light-equipped transmitter 1101 to the front surface side region. For example, the sheet metal side opening portion 1921 for back side attachment is a circular hole smaller in diameter than the front cover 1001 of the display light-equipped transmitter 1101 (in other words, the display light-equipped transmitter 1101 is larger in diameter than the sheet metal side opening portion 1921 for back side attachment).

(Configuration-Attachment Member)

The attachment member 1071 in FIG. 22 causes the display light-equipped transmitter 1101 to be provided in the back side region. Specifically, the attachment member 1071 is an attachment unit that sandwiches at least a part of the display light-equipped transmitter 1101 with the sheet metal 1092 such that at least a part of the front cover 1001 is exposed to the front surface side region via the sheet metal side opening portion 1921 for back side attachment and for attaching the front cover 1001 to the sheet metal 1092. The attachment member 1071 can be of any specific type and configuration. For example, the attachment member 1071 has a rectangular shape larger than the front cover 1001 in the direction along the front surface portion 1011 of the front cover 1001. As an example, the attachment member 1071 is provided with an attachment member side opening portion 1711 illustrated in FIG. 21.

(Configuration-Attachment Member-Attachment Member Side Opening Portion)

The attachment member side opening portion 1711 is an opening through which a part of the component plate 1005 is inserted. For example, the attachment member side opening portion 1711 is an opening through which a part of the component plate 1005 protruding to the back side (−Z direction) is inserted and is provided in the vicinity of the center of the attachment member 1071.

(Configuration-Cover Packing)

The cover packing 1072 in FIG. 22 is a sealing unit. At least a part of the cover packing 1072 is provided around the sheet metal side opening portion 1921 for back side attachment between the sheet metal 1092 and the front cover 1001. Specifically, the cover packing 1072 provides sealing between the sheet metal 1092 and the front cover 1001. FIG. 23 is a diagram in which FIG. 22 is enlarged in part. The cover packing 1072 can be of any specific type and configuration. For example, the cover packing 1072 has an annular shape as a whole, the cover packing 1072 is provided along the side surface portion 1012 of the front cover 1001, at least a part of the cover packing 1072 is provided along a side slightly inside the edge of the front surface portion 1011 of the front cover 1001, and the cover packing 1072 is integrally configured by means of a material having at least two types of properties. As an example, the cover packing 1072 is provided with a main body portion 1721 and a cover portion 1722.

(Configuration-Cover Packing-Main Body Portion)

The main body portion 1721 is a part constituting a part of the cover packing 1072. Specifically, the main body portion 1721 extends in the thickness direction (Z direction). For example, the main body portion 1721 is a reflective and non-light-transmitting portion that reflects and does not pass light. In addition, the main body portion 1721 is relatively soft and elastically deformable. The main body portion 1721 can be molded by any method. For example, the main body portion 1721 is molded by any molding method (such as so-called two-color molding) by means of a soft, elastic, and non-light-transmitting material that reflects and does not pass light (such as a so-called elastomer material).

(Configuration-Cover Packing-Cover Portion)

The cover portion 1722 is a part constituting another part of the cover packing 1072. Specifically, the cover portion 1722 is provided on the front surface side of the main body portion 1721. For example, at least a part of the cover portion 1722 slightly protrudes to the front surface side region along the edge of the sheet metal side opening portion 1921 for back side attachment and via the sheet metal side opening portion 1921 for back side attachment. In addition, the cover portion 1722 is a light-transmitting portion passing light similarly to the transmitting region 1013 of the front cover 1001 and is relatively hard. The cover portion 1722 can be molded by any method. For example, the cover portion 1722 is molded by any molding method (such as so-called two-color molding) by means of a light-transmitting hard material passing light (such as a resin material).

(Assembly and Installation Methods)

Next, methods for assembling and installing the display light-equipped transmitter 1101 will be described.

First, the component plate 1005 is attached to the attachment member 1071 in FIG. 22 by any specific method. For example, the attachment is performed by a part of the component plate 1005 being inserted through the attachment member side opening portion 1711 and a component plate fixing screw S1021 being continuously screwed into the component plate 1005 and the attachment member 1071.

Next, the remaining components of the display light-equipped transmitter 1101 illustrated in FIG. 14 (other than the cover packing 1072) are attached to the component plate 1005 by any fixing unit (such as screwing with a screw, engagement with an engagement structure, and fitting with a fitting structure).

Next, the attachment member 1071 is attached to the sheet metal 1092 by any specific method. For example, as illustrated in FIG. 22, the attachment is performed by the display light-equipped transmitter 1101 being provided in the back side region after the cover packing 1072 is provided around the front cover 1001, positioning being performed such that the front cover 1001 is exposed via the sheet metal side opening portion 1921 for back side attachment, and an attachment fitting A1011 being used. Here, the attachment fitting A1011 is an attachment member attachment unit that attaches the attachment member 1071 to the sheet metal 1092 and is fixed to both the attachment member 1071 and the sheet metal 1092 by any fixing unit (such as screwing with a screw and adhesion with an adhesive material). For example, the attachment fitting A1011 is a bent and fixed fitting. The assembly and installation of the display light-equipped transmitter 1101 are completed as a result.

(Light Emission)

Next, the light emission by the display light-equipped transmitter 1101 will be described. Described here is, for example, the optical path of light in a case where the light emitting unit 1003 has emitted light to the light guide 1002.

The light emitted by the light emitting unit 1003 is output from the transmitting region 1013 of the front cover 1001 to the front surface side region via the light guide 1002 as in the case of Embodiment 2. In this case, part of the light is directly output from the transmitting region 1013 to the front surface side region, some of the rest of the light is transmitted through the cover portion 1722 of the cover packing 1072 and output, and the remaining part of the light is reflected at the inner periphery of the main body portion 1721 in the cover packing 1072 and output.

In this case, in particular, a part of the cover portion 1722 of the cover packing 1072 protrudes to the front surface side region, and thus a user can visually recognize and confirm from every position in the front surface side region that a part of the display light-equipped transmitter 1101 emits light in red.

### Effect of Embodiment 3

In the present embodiment, the display light-equipped transmitter 1101 is provided in the back side region and is larger in diameter than the sheet metal side opening portion 1921 for back side attachment as described above. In addition, the display light-equipped transmitter 1101 is attached such that at least a part of the front cover 1001 is exposed to the front surface side region via the sheet metal side opening portion 1921 for back side attachment. Accordingly, for example, the display light-equipped transmitter 1101 can be attached such that the sheet metal 1091 is flat in the front surface side region, and thus it is possible to prevent the display light-equipped transmitter 1101 from acting as a hindrance. In addition, for example, the sheet metal side opening portion 1921 for back side attachment can be sealed by the display light-equipped transmitter 1101 and it is possible to prevent a contaminant such as rain and dust from entering the back side region via the exposing hole since the display light-equipped transmitter 1101 is larger in diameter than the sheet metal side opening portion 1921 for back side attachment.

In addition, by the cover packing 1072 being provided, it is possible, for example, to reliably prevent a contaminant such as rain and dust from entering the back side region via the sheet metal side opening portion 1921 for back side attachment.

In addition, the board cover side name plate portion 1621 illustrated in FIG. 15, which displays the connection-related information, is provided so as to be exposed on the back side (−Z direction) of the display light-equipped transmitter 1101. Accordingly, for example, the connection-related information can be visually recognized in a state where the appearance of the front surface side (+Z direction) of the display light-equipped transmitter 1101 is kept simple and the connection-related information can be displayed in a state where the design is maintained. As for previously proposed techniques for retrofitting a retrofit display light device into an existing transmitter in particular, the transmitter is embedded in an attachment target although connection-related information is displayed on the back side of the transmitter, and thus the retrofit display light device and the transmitter need to be removed for connection-related information confirmation and the removal is troublesome. In the case of the present application, however, the connection-related information can be easily confirmed by the display light-equipped transmitter 1101 going around into the back side region without being removed or disassembled from the attachment target in a case where the display light-equipped transmitter 1101 is provided in the back side region and attached such that at least a part of the front cover 1001 is exposed to the front surface side region via the sheet metal side opening portion 1921 for back side attachment.

### Modification Examples of Embodiment

Although each embodiment according to the invention has been described above, the specific configuration and means of the invention can be modified and improved in any manner within the scope of the technical idea of each invention described in the claims. Modification examples will be described below.

(Regarding Technical Problem and Advantageous Effects of Invention)

First of all, Technical Problem and Advantageous Effects of the Invention are not limited to the content described above and may vary with the implementation environment of the invention and details of the configuration of the invention. The problem described above may be solved only in part and the effects described above may be achieved only in part.

(Regarding Distribution and Integration)

In addition, the configuration described above is functionally conceptual and does not necessarily have to be physically configured as illustrated. In other words, the specific form of the distribution and integration of each part is not limited to the illustration and the whole or a part thereof can be configured by being functionally or physically distributed or integrated in any unit.

### Regarding Front Cover of Embodiment 1 (No. 1)

In addition, in Embodiment 1, the configurations of the transmitting region 13 and the non-transmitting region 14 of the front cover 1 may be changed in any manner. For example, the transmitting region 13 may be provided in only one of the front surface portions 11 and the side surface portion 12. In addition, the transmitting region 13 may have any shape insofar as the transmitting region 13 is not annular.

### Regarding Front Cover of Embodiment 1 (No. 2)

In addition, in Embodiment 1, the configurations of the non-transmitting layer L11 and the transmitting layer L12 of the front cover 1 may be changed in any manner. For example, the transmitting layer L12 may overlap with the non-transmitting layer L11 from the back side (−Z direction). In another example, the non-transmitting region 14 of the front cover 1 may be configured with only the non-transmitting layer L11 provided and without the non-transmitting layer L11 and the transmitting layer L12 overlapping with each other by the transmitting layer L12 overlapping with only a part of the non-transmitting layer L11 or the transmitting layer L12 not overlapping with the non-transmitting layer L11. In this case, any size relationship may be applied between the areas of the non-transmitting layer L11 and the transmitting layer L12.

### Regarding Light Guide of Embodiment 1

In addition, in Embodiment 1, the overall configuration of the light guide 2 may be changed in any manner. For example, the light guide 2 may be divided into any number and configured as two or more light guides. In another example, the light guide 2 may have any non-annular shape (such as a triangular shape and a rectangular shape).

### Regarding Attachment of Display Light-equipped Transmitter of Embodiment 1

In addition, the display light-equipped transmitter 100 of Embodiment 1 may be attached to the sheet metal 91 in any manner. Specifically, the display light-equipped transmitter 100 may be attached from the front surface side (+Z direction) to the sheet metal 91 via any attachment adapter or may be attached from the back side (−Z direction) to the sheet metal 91 by any means.

### Regarding Front Cover of Embodiments 2 and 3

In addition, in Embodiments 2 and 3, the configurations of the transmitting region 1013 and the non-transmitting region 1014 of the front cover 1001 may be changed in any manner. For example, the transmitting region 1013 may be provided in only one of the front surface portions 1011 and the side surface portion 1012. In addition, the transmitting region 1013 may have any shape insofar as the transmitting region 1013 is not annular.

### Regarding Light Guide of Embodiments 2 and 3

In addition, in Embodiments 2 and 3, the overall configuration of the light guide 1002 may be changed in any manner. For example, the light guide 1002 may be divided into any number and configured as two or more light guides. In another example, the light guide 1002 may have any non-annular shape (such as a triangular shape and a rectangular shape).

### Regarding Attachment of Display Light-equipped Transmitters of Embodiments 2 and 3 (No. 1)

In addition, direct attachment to the sheet metal 1091 may be performed with the attachment adapter 1063 omitted with regard to the display light-equipped transmitter 1100 of Embodiment 2. Direct attachment to the sheet metal 1092 may be performed with the cover packing 1072 omitted with regard to the display light-equipped transmitter 1101 of Embodiment 3. Specifically, the attachment may be performed by any fixing unit (such as screwing with a screw, engagement with an engagement structure, and fitting with a fitting structure) in this case.

### Regarding Attachment of Display Light-equipped Transmitters of Embodiments 2 and 3 (No. 2)

In addition, the display light-equipped transmitter 1100 of Embodiment 2 may be attached flat to the sheet metal 1091 by being embedded in the sheet metal 1091.

### Effects of Embodiments 2 and 3

In addition, for example, the display light-equipped transmitters 1100 and 1101 described in Embodiments 2 and 3 (configurations illustrated in FIGS. 14 and 15 to be specific) can be attached from the front surface sides (+Z direction) and the back sides (−Z direction) of the sheet metals 1091 and 1092 as targets to which the display light-equipped transmitters 1100 and 1101 are attached. In other words, light can be output to the side surface side as well, by the side surface portion 1012 being exposed, in a case where attachment is performed from the front surface side (+Z direction) as in the display light-equipped transmitter 1100 of Embodiment 2 and the light from the side surface portion 1012 can be reflected by the inner periphery of the main body portion 1721 to be output to the side surface side as well via a part of the cover portion 1722 protruding to the front surface side region in a case where attachment is performed from the back side (−Z direction) as in the display light-equipped transmitter 1101 of Embodiment 3, and thus attachment from the front surface side (+Z direction) and attachment from the back side (−Z direction) are possible and displayability can be improved.

### Regarding Interpretation of Term of Display Light-equipped Transmitter in Embodiments 2 and 3

In addition, regarding the term of “display light-equipped transmitter”, configurations common to Embodiments 2 and 3 may be interpreted as “display light-equipped transmitter”, configurations used only in Embodiment 2 may be interpreted as configurations optionally used for front surface side attachment, or configurations used only in Embodiment 3 may be interpreted as configurations optionally used for back side attachment. As for “display light-equipped transmitter” including the configurations common to Embodiments 2 and 3 and pertaining to this case of interpretation, the display light-equipped transmitter is attached to the attachment target from the front surface side (+Z direction) or the back side (−Z direction), and thus the display light-equipped transmitter can be, for example, attached from the front surface side (+Z direction) to the attachment target so as to protrude as in Embodiment 2 or attached flat to the attachment target from the back side (−Z direction). As a result, the display light-equipped transmitter can be adapted to an attachment environment and it is possible to improve the visibility of the display light-equipped transmitter or prevent the display light-equipped transmitter from acting as a hindrance.

One embodiment of the present invention provides a display light-equipped transmitter providing notification of an abnormality in a monitoring region, the display light-equipped transmitter comprises: a light emitting unit; and a front cover.

According to this embodiment, since the display light-equipped transmitter comprises a light emitting unit and a front cover, for example, the design of the display light-equipped transmitter can be improved, or the position of the display light-equipped transmitter can be reliably recognized by the user.

Another embodiment of the present invention provides the alarm apparatus according to the above embodiment, wherein the front cover covers the light emitting unit from a front side of the display light-equipped transmitter, the front cover is provided with a transmitting region as a region transmitting light emitted by the light emitting unit to an outside of the display light-equipped transmitter on a front side of the display light-equipped transmitter and a non-transmitting region as a region not transmitting light emitted by the light emitting unit to an outside of the display light-equipped transmitter on a front side of the display light-equipped transmitter, and the transmitting region and the non-transmitting region of the front cover are configured integrally with each other.

According to this embodiment, since the transmitting region and the non-transmitting region of the front cover are configured integrally with each other, for example, no gap or the like is provided between the transmitting region and the non-transmitting region, and thus it is possible to prevent a contaminant such as rain and dust from entering the display light-equipped transmitter. In addition, for example, it is possible to give an impression of unity and integrity with regard to the entire front cover, and thus the design of the display light-equipped transmitter can be improved.

Another embodiment of the present invention provides the alarm apparatus according to the above embodiment, wherein the front cover is provided with: a non-transmitting layer molded of a non-transmitting material as a material transmitting no light; and a transmitting layer molded of a transmitting material as a material transmitting light, only a part of the transmitting layer overlapping with the non-transmitting layer, the transmitting region is a region where the non-transmitting layer and the transmitting layer do not overlap with each other out of a region where the transmitting layer is provided, and the non-transmitting region is a region including a region where the non-transmitting layer and the transmitting layer overlap with each other.

According to this embodiment, since the transmitting region is a region where the non-transmitting layer and the transmitting layer do not overlap with each other out of a region where the transmitting layer is provided, and the non-transmitting region is a region including a region where the non-transmitting layer and the transmitting layer overlap with each other, for example, the functions of the transmitting region and the non-transmitting region can be reliably ensured by the transmitting layer and the non-transmitting layer being used, and thus the shape of the transmitting region can be conspicuous with light in the display light-equipped transmitter and the position of the display light-equipped transmitter can be reliably displayed. In addition, for example, the transmitting layer can be provided in both the transmitting region and the non-transmitting region, and thus the display light-equipped transmitter can be coated with the transmitting layer and a sense of luxury can be produced for the display light-equipped transmitter.

Another embodiment of the present invention provides the alarm apparatus according to the above embodiment, comprising: a back cover covering the light emitting unit from a back side of the display light-equipped transmitter; and an engagement unit that engages the front cover with the back cover.

According to this embodiment, since an engagement unit that engages the front cover with the back cover is provided, for example, the front cover and the back cover can be temporarily fixed to each other and thus it is possible to provide the display light-equipped transmitter that is assembled with ease.

Another embodiment of the present invention provides the alarm apparatus according to the above embodiment, comprising: a back cover covering the light emitting unit from a back side of the display light-equipped transmitter; and a screwing unit that fixes the front cover to the back cover by screwing, the screwing unit being provided in the display light-equipped transmitter, wherein the front cover is provided with: a communication opening as an opening leading to an inner portion of the display light-equipped transmitter; an opening and closing plate opening and closing the communication opening; and a screwed unit into which the screwing unit is screwed, the screwed unit being provided in the display light-equipped transmitter, the screwing unit is screwed into the screwed unit via the communication opening, and the screwing unit is exposed to an outside of the display light-equipped transmitter via the communication opening in a case where the opening and closing plate is opened and is not exposed to an outside of the display light-equipped transmitter via the communication opening in a case where the opening and closing plate is closed.

According to this embodiment, since the screwing unit that fixes the front cover to the back cover by screwing is exposed to an outside of the display light-equipped transmitter via the communication opening in a case where the opening and closing plate is opened and is not exposed to an outside of the display light-equipped transmitter via the communication opening in a case where the opening and closing plate is closed, for example, it is possible to operate the screwing unit by opening the opening and closing plate or hide the screwing unit by closing the opening and closing plate, and thus the assembly can be further facilitated with the design of the display light-equipped transmitter maintained. In addition, in a case where, for example, the screwing unit is provided in addition to the engagement unit described above, the front cover and the back cover can be fixed to each other by the screwing unit with the mutual rotation of the front cover and the back cover locked by the screwing unit, and thus the display light-equipped transmitter can be assembled with ease.

Another embodiment of the present invention provides the alarm apparatus according to the above embodiment, wherein the front cover is provided with: a front surface portion covering the light emitting unit from a front surface side of the display light-equipped transmitter; and a side surface portion covering the light emitting unit from a side surface side of the display light-equipped transmitter, the front cover is provided with: a transmitting region as a region transmitting light emitted by the light emitting unit to an outside of the display light-equipped transmitter on a front surface side of the display light-equipped transmitter and an outside of the display light-equipped transmitter on a side surface side of the display light-equipped transmitter; and a non-transmitting region as a region not transmitting light emitted by the light emitting unit to an outside of the display light-equipped transmitter on a front surface side of the display light-equipped transmitter and an outside of the display light-equipped transmitter on a side surface side of the display light-equipped transmitter, and the transmitting region is provided in the front surface portion and the side surface portion.

According to this embodiment, since the transmitting region is provided in the front surface portion and the side surface portion, for example, it is possible to emit the light of the light emitting unit to both the front surface portion side and the side surface portion side, and thus users on the front and side surface sides of the display light-equipped transmitter can visually recognize the light and reliably recognize the position of the display light-equipped transmitter.

Another embodiment of the present invention provides the alarm apparatus according to the above embodiment, wherein a center side non-transmitting region as at least a part of the non-transmitting region is provided on a center side of the front surface portion in a direction along the front surface portion, and the transmitting region is provided from an outer peripheral side of the front surface portion surrounding the center side non-transmitting region to the side surface portion.

According to this embodiment, since the transmitting region is provided from an outer peripheral side of the front surface portion surrounding the center side non-transmitting region to the side surface portion, for example, light can be continuously emitted from the front surface portion to the side surface portion, and thus a user on a diagonal side between the front and side surface sides as well as users on the front and side surface sides of the display light-equipped transmitter can visually recognize light, and thus users can further reliably recognize the position of the display light-equipped transmitter.

Another embodiment of the present invention provides the alarm apparatus according to the above embodiment, wherein the display light-equipped transmitter is attached to an attachment target from a front surface side or a back side.

According to this embodiment, since the display light-equipped transmitter is attached to an attachment target from a front surface side or a back side, for example, the display light-equipped transmitter can be attached from the front surface side to the attachment target so as to protrude or attached flat to the attachment target from the back side, and thus the display light-equipped transmitter can be adapted to an attachment environment and it is possible to improve the visibility of the display light-equipped transmitter or prevent the display light-equipped transmitter from acting as a hindrance.

Another embodiment of the present invention provides the alarm apparatus according to the above embodiment, wherein the display light-equipped transmitter is attached to the attachment target from a front surface side of the attachment target, and the display light-equipped transmitter is provided with: a back cover covering the light emitting unit from a back side of the display light-equipped transmitter; and an attachment unit that attaches the back cover to the attachment target, the attachment unit being provided between the attachment target and the back cover.

According to this embodiment, since an attachment unit is provided between the attachment target and the back cover to attach the back cover to the attachment target, for example, the display light-equipped transmitter can be attached from the front surface side to the attachment target, and thus no work is necessary on the back side of the attachment target and the workability of the display light-equipped transmitter can be improved. In addition, for example, the amount of protrusion of the display light-equipped transmitter with respect to the attachment target can be increased, and thus the visibility of the display light-equipped transmitter can be improved.

Another embodiment of the present invention provides the alarm apparatus according to the above embodiment, wherein the display light-equipped transmitter is attached to the attachment target from a back side of the attachment target partitioning a front surface side region as a region on a front surface side of the attachment target and a back side region as a region on a back side of the attachment target from each other and provided with an exposing hole for exposing at least a part of the display light-equipped transmitter to the front surface side region, the display light-equipped transmitter is provided in the back side region and larger in diameter than the exposing hole, and the display light-equipped transmitter is provided with an attachment unit that sandwiches at least a part of the display light-equipped transmitter with the attachment target such that at least a part of the front cover is exposed to the front surface side region via the exposing hole, the attachment unit attaching the front cover to the attachment target.

According to this embodiment, since the display light-equipped transmitter is provided in the back side region and larger in diameter than the exposing hole and since the display light-equipped transmitter is provided such that at least a part of the front cover is exposed to the front surface side region via the exposing hole, for example, the display light-equipped transmitter can be attached such that the attachment target is flat in the front surface side region, and thus it is possible to prevent the display light-equipped transmitter from acting as a hindrance. In addition, for example, since the display light-equipped transmitter is larger in diameter than the exposing hole, the exposing hole can be sealed by the display light-equipped transmitter and it is possible to prevent a contaminant such as rain and dust from entering the back side region via the exposing hole.

Another embodiment of the present invention provides the alarm apparatus according to the above embodiment, comprising a sealing unit that provides sealing between the attachment target and the front cover, at least a part of the sealing unit being provided around the exposing hole between the attachment target and the front cover.

According to this embodiment, since a sealing unit is provided, for example, it is possible to reliably prevent a contaminant such as rain and dust from entering the back side region via the exposing hole.

Another embodiment of the present invention provides the alarm apparatus according to the above embodiment, comprising an inspection information display unit that displays inspection information on the display light-equipped transmitter, the inspection information display unit being provided in the display light-equipped transmitter, wherein the front cover is provided with: a communication opening as an opening leading to an inner portion of the display light-equipped transmitter, the display light-equipped transmitter being operated via the communication opening; and an opening and closing plate opening and closing the communication opening, and the inspection information display unit is exposed to an outside of the display light-equipped transmitter via the communication opening in a case where the opening and closing plate is opened and is not exposed to an outside of the display light-equipped transmitter via the communication opening in a case where the opening and closing plate is closed.

According to this embodiment, since the inspection information display unit that displays inspection information is exposed to an outside of the display light-equipped transmitter in a case where the opening and closing plate is opened and is not exposed to an outside of the display light-equipped transmitter in a case where the opening and closing plate is closed, for example, the inspection information display unit can be exposed only when necessary, and thus the inspection information can be visually recognized in a state where the appearance of the display light-equipped transmitter is kept simple and the inspection information can be displayed in a state where the design is maintained. As for previously proposed techniques for retrofitting a retrofit display light device into an existing transmitter in particular, inspection information is provided at a position that can be visually recognized only after the retrofit display light device is removed from the transmitter, and thus the retrofit display light device needs to be removed for inspection information confirmation and the removal is troublesome. In the case of the present application, however, the inspection information can be easily confirmed without the display light-equipped transmitter being removed or disassembled from the attachment target.

Another embodiment of the present invention provides the alarm apparatus according to the above embodiment, comprising a connection-related information display unit that displays connection-related information as information related to electrical connection between the display light-equipped transmitter and an external device, the connection-related information display unit being provided so as to be exposed to an outside of the display light-equipped transmitter on a back side of the display light-equipped transmitter.

According to this embodiment, since a connection-related information display unit that displays connection-related information is provided so as to be exposed on a back side of the display light-equipped transmitter, for example, the connection-related information can be visually recognized in a state where the appearance of the front surface side of the display light-equipped transmitter is kept simple and the connection-related information can be displayed in a state where the design is maintained. As for previously proposed techniques for retrofitting a retrofit display light device into an existing transmitter in particular, the transmitter is embedded in an attachment target although connection-related information is displayed on the back side of the transmitter, and thus the retrofit display light device and the transmitter need to be removed for connection-related information confirmation and the removal is troublesome. In the case of the present application, however, the connection-related information can be easily confirmed by the display light-equipped transmitter going around into the back side region without being removed or disassembled from the attachment target in a case where the display light-equipped transmitter is provided in the back side region and attached such that at least a part of the front cover is exposed to the front surface side region via the exposing hole.

### REFERENCE SIGNS LIST

1 Front cover

2 Light guide

3 Light emitting unit

5 Component plate

11 Front surface portion

12 Side surface portion

13 Transmitting region

14 Non-transmitting region

15 Opening and closing opening portion

16 Display plate

17 Exposing opening portion

18 Front cover side engagement portion

19 Front cover side fixing portion

41 Display light board

42 Protective plate

43 Pressing spring

44 Switch

51 Component plate side front cover engagement portion

52 Component plate side front cover screwing portion

53 First component plate side name plate portion

54 Second component plate side name plate portion

61 Transmitter board

62 Board cover

91 Sheet metal

100 Display light-equipped transmitter

131 Left transmitting region

132 Right transmitting region

141 Center side non-transmitting region

142 Upper non-transmitting region

143 Lower non-transmitting region

144 Side surface side non-transmitting region

1001 Front cover

1002 Light guide

1003 Light emitting unit

1005 Component plate

1011 Front surface portion

1012 Side surface portion

1013 Transmitting region

1014 Non-transmitting region

1015 Opening and closing opening portion

1016 Display plate

1017 Exposing opening portion

1041 Display light board

1042 Protective plate

1043 Pressing spring

1044 Switch

1051 First component plate side name plate portion

1052 Second component plate side name plate portion

1061 Transmitter board

1062 Board cover

1063 Attachment adapter

1071 Attachment member

1072 Cover packing

1091 Sheet metal

1092 Sheet metal

1100 Display light-equipped transmitter

1101 Display light-equipped transmitter

1131 Left transmitting region

1132 Right transmitting region

1141 Center side non-transmitting region

1142 Upper non-transmitting region

1143 Lower non-transmitting region

1144 Side surface side non-transmitting region

1621 Board cover side name plate portion

1631 Adapter side opening portion

1632 Component plate screwing hole

1633 Sheet metal screwing hole

1711 Attachment member side opening portion

1721 Main body portion

1722 Cover portion

1911 Sheet metal side opening portion for front side attachment

1921 Sheet metal side opening portion for back side attachment

A1011 Attachment fitting

L11 Non-transmitting layer

L12 Transmitting layer

S11 Front cover fixing screw

S12 Component plate fixing screw

S1011 Component plate fixing screw

S1021 Component plate fixing screw

1. A display light-equipped transmitter providing notification of an abnormality in a monitoring region, the display light-equipped transmitter comprising:
a light emitting unit; and
a front cover.

2. The display light-equipped transmitter according to claim 1, wherein
the front cover covers the light emitting unit from a front side of the display light-equipped transmitter,
the front cover is provided with a transmitting region as a region transmitting light emitted by the light emitting unit to an outside of the display light-equipped transmitter on a front side of the display light-equipped transmitter and a non-transmitting region as a region not transmitting light emitted by the light emitting unit to an outside of the display light-equipped transmitter on a front side of the display light-equipped transmitter, and
the transmitting region and the non-transmitting region of the front cover are configured integrally with each other.

3. The display light-equipped transmitter according to claim 2, wherein
the front cover is provided with:
a non-transmitting layer molded of a non-transmitting material as a material transmitting no light; and
a transmitting layer molded of a transmitting material as a material transmitting light, only a part of the transmitting layer overlapping with the non-transmitting layer,
the transmitting region is a region where the non-transmitting layer and the transmitting layer do not overlap with each other out of a region where the transmitting layer is provided, and
the non-transmitting region is a region including a region where the non-transmitting layer and the transmitting layer overlap with each other.

4. The display light-equipped transmitter according to claim 2, comprising:
a back cover covering the light emitting unit from a back side of the display light-equipped transmitter; and
an engagement unit that engages the front cover with the back cover.

5. The display light-equipped transmitter according to claim 2, comprising:
a back cover covering the light emitting unit from a back side of the display light-equipped transmitter; and
a screwing unit that fixes the front cover to the back cover by screwing, the screwing unit being provided in the display light-equipped transmitter, wherein
the front cover is provided with:
a communication opening as an opening leading to an inner portion of the display light-equipped transmitter;
an opening and closing plate opening and closing the communication opening; and
a screwed unit into which the screwing unit is screwed, the screwed unit being provided in the display light-equipped transmitter,
the screwing unit is screwed into the screwed unit via the communication opening, and
the screwing unit is exposed to an outside of the display light-equipped transmitter via the communication opening in a case where the opening and closing plate is opened and is not exposed to an outside of the display light-equipped transmitter via the communication opening in a case where the opening and closing plate is closed.

6. The display light-equipped transmitter according to claim 1, wherein
the front cover is provided with:
a front surface portion covering the light emitting unit from a front surface side of the display light-equipped transmitter; and
a side surface portion covering the light emitting unit from a side surface side of the display light-equipped transmitter,
the front cover is provided with:
a transmitting region as a region transmitting light emitted by the light emitting unit to an outside of the display light-equipped transmitter on a front surface side of the display light-equipped transmitter and an outside of the display light-equipped transmitter on a side surface side of the display light-equipped transmitter; and
a non-transmitting region as a region not transmitting light emitted by the light emitting unit to an outside of the display light-equipped transmitter on a front surface side of the display light-equipped transmitter and an outside of the display light-equipped transmitter on a side surface side of the display light-equipped transmitter, and
the transmitting region is provided in the front surface portion and the side surface portion.

7. The display light-equipped transmitter according to claim 6, wherein
a center side non-transmitting region as at least a part of the non-transmitting region is provided on a center side of the front surface portion in a direction along the front surface portion, and
the transmitting region is provided from an outer peripheral side of the front surface portion surrounding the center side non-transmitting region to the side surface portion.

8. The display light-equipped transmitter according to claim 6, wherein the display light-equipped transmitter is attached to an attachment target from a front surface side or a back side.

9. The display light-equipped transmitter according to claim 8, wherein
the display light-equipped transmitter is attached to the attachment target from a front surface side of the attachment target, and
the display light-equipped transmitter is provided with:
a back cover covering the light emitting unit from a back side of the display light-equipped transmitter; and
an attachment unit that attaches the back cover to the attachment target, the attachment unit being provided between the attachment target and the back cover.

10. The display light-equipped transmitter according to claim 8, wherein
the display light-equipped transmitter is attached to the attachment target from a back side of the attachment target partitioning a front surface side region as a region on a front surface side of the attachment target and a back side region as a region on a back side of the attachment target from each other and provided with an exposing hole for exposing at least a part of the display light-equipped transmitter to the front surface side region,
the display light-equipped transmitter is provided in the back side region and larger in diameter than the exposing hole, and
the display light-equipped transmitter is provided with an attachment unit that sandwiches at least a part of the display light-equipped transmitter with the attachment target such that at least a part of the front cover is exposed to the front surface side region via the exposing hole, the attachment unit attaching the front cover to the attachment target.

11. The display light-equipped transmitter according to claim 10, comprising a sealing unit that provides sealing between the attachment target and the front cover, at least a part of the sealing unit being provided around the exposing hole between the attachment target and the front cover.

12. The display light-equipped transmitter according to claim 6, comprising an inspection information display unit that displays inspection information on the display light-equipped transmitter, the inspection information display unit being provided in the display light-equipped transmitter, wherein
the front cover is provided with:
a communication opening as an opening leading to an inner portion of the display light-equipped transmitter, the display light-equipped transmitter being operated via the communication opening; and
an opening and closing plate opening and closing the communication opening, and
the inspection information display unit is exposed to an outside of the display light-equipped transmitter via the communication opening in a case where the opening and closing plate is opened and is not exposed to an outside of the display light-equipped transmitter via the communication opening in a case where the opening and closing plate is closed.

13. The display light-equipped transmitter according to claim 6, comprising a connection-related information display unit that displays connection-related information as information related to electrical connection between the display light-equipped transmitter and an external device, the connection-related information display unit being provided so as to be exposed to an outside of the display light-equipped transmitter on a back side of the display light-equipped transmitter.
